(19) United States
(12) Patent Application Publication
(10) Pub. No.: US 2015/0199698 A1
(43) Pub. Date: Jul. 16, 2015

(54) DISPLAY METHOD, STAY INFORMATION DISPLAY SYSTEM, AND DISPLAY CONTROL DEVICE

(71) Applicant: Panasonic Intellectual Property Corporation of America, Torrance, CA (US)

(72) Inventors: HIROSHI YOSHITAKE, Osaka (JP); TOMOYUKI KARIBE, Osaka (JP); TETSUYA INOUE, Kyoto (JP); TAKESHI ISHIHARA, Osaka (JP)

(21) Appl. No.: 14/594,381

(22) Filed: Jan. 12, 2015

Related U.S. Application Data
(60) Provisional application No. 61/927,126, filed on Jan. 14, 2014.

(30) Foreign Application Priority Data
Aug. 26, 2014 (JP) 2014-171924

(51) Int. Cl. G06Q 30/02; G06T 11/60; G09G 5/30; G06K 9/00; G06K 9/62

(52) U.S. Cl. CPC G06Q 30/0205; G06K 9/00369; G06K 9/00342; G06K 9/6277; G09G 5/30; G06T 11/60; G09G 2320/08; G09G 2320/0686; G06T 2210/61

(57) ABSTRACT

In a stay information display system, threshold values are determined in accordance with at least any one of the display target period and the display target store, by using condition information that specifies a condition for determining threshold values used to classify the numbers of persons staying in the plurality of areas within the store. The calculated numbers of persons staying in the plurality of areas are classified by using the determined threshold values, a map screen on which staying behaviors of persons in the plurality of areas are mapped onto a layout screen of the store by using display styles in accordance with a result of the classification is generated, and the map screen is displayed on the display.

### CROSS REFERENCES TO RELATED APPLICATIONS

This application claims priority to U.S. provisional Patent Application No. 61/927,126, filed on Jan. 14, 2014, and Japanese Patent Application No. 2014-171924, filed on Aug. 26, 2014, the contents of which are hereby incorporated by reference.

### BACKGROUND

1. Technical Field

The present disclosure relates to a technique for displaying in-store customer behavior.

2. Description of the Related Art

Japanese Unexamined Patent Application Publication No. 2006-350751 discloses a sales analysis apparatus for recording video images captured by a plurality of cameras installed in a store in a video database in association with time information, creating moving-path data indicating a path along which a monitoring target has moved in a store, and displaying the moving-path data on a display.

### SUMMARY

In an aspect of the present disclosure, there is provided a display method in a stay information display system that includes a management device that collects stay information on stays of persons in a store, and a display control device that displays staying behavior of persons in the store on a display by using the collected stay information. The display method includes: receiving state information including a location at which a person stays in the store, the state information being generated based on video data obtained by capturing an image of inside of the store; generating stay information in which a location at which a person stays in the store and date and time at which the person stays in the store are associated with each other, by using the received state information; saving the generated stay information in a storage in association with store information indicating the store; selecting a display target period and a display target store; calculating the numbers of persons staying in a plurality of areas within the display target store for the display target period, by using the saved stay information; determining threshold values in accordance with at least any one of the display target period and the display target store, by using condition information that specifies a condition for determining threshold values used to classify the numbers of persons staying in the plurality of areas within the store; and classifying the calculated numbers of persons staying in the plurality of areas by using the determined threshold values, generating a map screen on which staying behaviors of persons in the plurality of areas are mapped onto a layout screen of the store by using display styles in accordance with a result of the classification, and displaying the map screen on the display.

The above-described generic or specific aspects may be implemented by a system, an apparatus, a method, and a computer program, or may be implemented by any combination of a system, an apparatus, a method, and a computer program.

### BRIEF DESCRIPTION OF THE DRAWINGS

FIG. 1 is a system configuration diagram illustrating an example configuration of a stay information display system according to an embodiment of the present disclosure.

FIG. 2 is a system configuration diagram illustrating another example configuration of the stay information display system according to the embodiment of the present disclosure.

FIG. 3 is a block diagram illustrating an example configuration of a management device and a display control device according to the embodiment of the present disclosure.

FIG. 4 is a diagram illustrating an example data configuration of store list information and area setting information according to the embodiment of the present disclosure.

FIG. 5 is a diagram illustrating an example of stay information according to the embodiment of the present disclosure.

FIG. 6 is a diagram illustrating another example of stay information according to the embodiment of the present disclosure.

FIG. 7 is a diagram illustrating another example of stay information according to the embodiment of the present disclosure.

FIG. 8 is a diagram illustrating an example of condition information according to the embodiment of the present disclosure.

FIG. 9A is a diagram illustrating another example of condition information according to the embodiment of the present disclosure.

FIG. 9B is a diagram illustrating another example of condition information according to the embodiment of the present disclosure.

FIG. 9C is a diagram illustrating another example of condition information according to the embodiment of the present disclosure.

FIG. 10 is a layout diagram in which a department within a store is divided into a plurality of areas according to the embodiment of the present disclosure.

FIG. 11 is a diagram illustrating another example of the layout diagram in which a department within a store is divided into a plurality of areas according to the embodiment of the present disclosure.

FIG. 12 is a diagram illustrating an example of a store map screen on which designated areas are set according to the embodiment of the present disclosure.

FIG. 13 is a diagram illustrating an example of a map screen according to the embodiment of the present disclosure.

FIG. 14 is a diagram illustrating another example of a map screen according to the embodiment of the present disclosure.

FIG. 15 is a diagram illustrating an example of a display screen when the period from 19:00 to 22:00 is selected as a display target period according to the embodiment of the present disclosure.

FIG. 16 is a diagram illustrating an example of a display screen on which a map screen for 21:40 is displayed according to the embodiment of the present disclosure.

FIG. 17 is a diagram illustrating another example of a display screen when the period from 19:00 to 22:00 is selected as a display target period according to the embodiment of the present disclosure.

FIG. 18 is a diagram illustrating an example of a display screen on which a map screen for 21:40, which is obtained one hour and ten minutes later after the map screen illustrated in FIG. 17, is displayed according to the embodiment of the present disclosure.

FIG. 19 is a diagram illustrating an example of a display screen when four stores are selected as display target stores according to the embodiment of the present disclosure.

FIG. 20 is a diagram illustrating an example of a display screen when a store (A) is selected according to the embodiment of the present disclosure.

FIG. 21 is a diagram illustrating an example of a display screen when a store (B) is selected according to the embodiment of the present disclosure.

FIG. 22 is a diagram illustrating an example of a login screen according to the embodiment of the present disclosure.

FIG. 23 is a diagram illustrating an example of a menu screen according to the embodiment of the present disclosure.

FIG. 24 is a diagram illustrating an example of an in-store customer behavior map screen according to the embodiment of the present disclosure.

FIG. 25 is a diagram illustrating an example of an in-store customer behavior map screen when a “graph display” tab is designated according to the embodiment of the present disclosure.

FIG. 26 is a diagram illustrating an example of an in-store customer behavior map screen on which graph detail information is displayed according to the embodiment of the present disclosure.

FIG. 27 is a diagram illustrating an example of a customer class distribution graph screen according to the embodiment of the present disclosure.

FIG. 28 is a diagram illustrating an example of a customer class distribution graph screen when a “day-to-day graph” is selected according to the embodiment of the present disclosure.

FIG. 29 is a diagram illustrating an example of an activities distribution graph screen according to the embodiment of the present disclosure.

FIG. 30 is a diagram illustrating an activities distribution graph screen when a “day-to-day graph” is designated according to the embodiment of the present disclosure.

FIG. 31 is a diagram illustrating an example of an area setting screen according to the embodiment of the present disclosure.

FIG. 32 is a diagram illustrating an example of a store setting screen according to the embodiment of the present disclosure.

FIG. 33 is a diagram illustrating an example of a group setting screen according to the embodiment of the present disclosure.

FIG. 34 is a sequence diagram illustrating the operation in a collection phase according to the embodiment of the present disclosure.

FIG. 35 is a flowchart illustrating the operation in a display phase according to the embodiment of the present disclosure.

FIG. 36 is a diagram illustrating another example configuration of a stay information display system according to the embodiment of the present disclosure.

### DETAILED DESCRIPTION

Findings on which the present disclosure is based

In the related art, information regarding the behavior of customers in a store is collected and is used as analysis information on product items for sale which are displayed in a department within the store. One method for collecting information regarding customer behavior involves a supervisor collecting information regarding the behavior of customers by visually checking a particular area. Another method involves automatically collecting information regarding the behavior of customers using a camera or a sensor. The sales analysis apparatus described in Japanese Unexamined Patent Application Publication No. 2006-350751 given above (hereinafter referred to as “the sales analysis apparatus of the related art”) uses the latter method.

As described above, in the sales analysis apparatus of the related art, moving-path data indicating a path along which a monitoring target has moved in a store is displayed superimposed on a store layout diagram. In the sales analysis apparatus of the related art, furthermore, when a plurality of customers are selected by a viewer, pieces of moving-path data of the selected plurality of customers are displayed superimposed on the store layout diagram so that the pieces of moving-path data are laid on top of one another.

Since the sales analysis apparatus of the related art is configured to simultaneously display a plurality of pieces of moving-path data, it may be difficult for a viewer to visually recognize the individual pieces of moving-path data if the number of pieces of moving-path data reaches a certain value or more. In addition, moving-path data merely indicates a course or path that a customer follows, and it is difficult for a viewer to identify in which location the customer stopped, or stayed, in the store, by using the moving-path data. Thus, the sales analysis apparatus of the related art has a problem in that it is difficult to provide an appropriate presentation of the customer's staying behavior in each area within a store.

Accordingly, an embodiment of the present disclosure provides a technique for appropriately presenting the states of customers who have stopped in each area within a store by displaying the states of customers who have stopped in each area within the store in a distinguishable manner by using a different display style in accordance with the number of customers staying in the area.

In an aspect of the present disclosure, there is provided a display method in a stay information display system that includes a management device that collects stay information on stays of persons in a store, and a display control device that displays staying behavior of persons in the store on a display by using the collected stay information. The display method includes receiving state information including a location at which a person stays in the store, the state information being generated based on video data obtained by capturing an image of inside of the store; generating stay information in which a location at which a person stays in the store and date and time at which the person stays in the store are associated with each other, by using the received state information; saving the generated stay information in a storage in association with store information indicating the store; selecting a display target period and a display target store; calculating the numbers of persons staying in a plurality of areas within the display target store for the display target period, by using the saved stay information; determining threshold values in accordance with at least any one of the display target period and the display target store, by using condition information that specifies a condition for determining threshold values used to classify the numbers of persons staying in the plurality of areas within the store; classifying the calculated numbers of persons staying in the plurality of areas by using the determined threshold values; generating a map screen on which staying behaviors of persons in the plurality of areas are mapped onto a layout screen of the store by using display styles in accordance with a result of the classification, and displaying the map screen on the display.

In this case, state information including a location at which a person stays in the store is received, and stay information in which a location at which a person stays in the store and date and time at which the person stays in the store are associated with each other is generated by using the state information. The stay information is saved in a storage device in association with store information.

Then, a display target period and a display target store are selected, and the numbers of persons staying in the respective areas within the selected display target store for the selected display target period are calculated. The numbers of persons staying in the respective areas are classified by using threshold values determined in accordance with at least any one of the display target period and the display target store. Then, a map screen on which behaviors of the persons staying in the respective areas are displayed using display styles in accordance with a result of the classification is displayed on a display. Accordingly, a user is able to view the map screen on which the behaviors of persons staying in the respective areas are presented in an easy-to-understand way.

In addition, the numbers of persons staying in the respective areas are classified by using threshold values determined in accordance with at least any one of the display target store and the display target period. Accordingly, the numbers of persons staying in the respective areas may be appropriately classified in accordance with the display target store, the display target period, or the like. Thus, it may be possible to display the behaviors of persons staying in the respective areas by using appropriate display styles in accordance with the display target store or the display target period, compared to the case where the same threshold value are uniformly used for classification.

In the aspect described above, the condition information may be information in which a display style is associated with each of a plurality of reference values, each of which is defined by the number of persons staying per unit time. The determining may include correcting the reference values using durations indicated by the display target period, and the threshold values may be determined by using the condition information in which the reference values are corrected.

In this case, a threshold value is determined by correction of condition information, in which a display style is associated with each of a plurality of reference values, by using a duration indicated by the display target period. Accordingly, if condition information for determining threshold values is not stored for each display target period, a piece of condition information is stored, thereby allowing threshold values to be appropriately determined in accordance with the display target period.

In the aspect described above, furthermore, the condition information may include a plurality of pieces of sub-condition information, each corresponding to one of a plurality of time periods. Each of the plurality of pieces of sub-condition information may be information in which a display style is associated with each of a plurality of reference values defined by the number of staying persons. In the determining, the threshold values may be determined by using reference values included in a piece of sub-condition information corresponding to a time period indicated by the display target period among the plurality of pieces of sub-condition information.

In a store, the number of visitors may differ in accordance with the time period such as an on-peak period or an off-peak period. In this case, if the same threshold value is uniformly used for the classification of the numbers of persons staying in the respective areas, it may be difficult to appropriately classify the behaviors of persons staying in the respective areas. Accordingly, in the aspect described above, a plurality of pieces of sub-condition information each corresponding to a time period is stored. In addition, threshold values are determined by using the sub-condition information corresponding to the time period indicated by the display target period. Thus, it may be possible to display the behaviors of persons staying in the respective areas by using appropriate threshold values in accordance with the time period such as an on-peak period or an off-peak period.

In the aspect described above, furthermore, the condition information may include a plurality of pieces of sub-condition information, each corresponding to a location condition of the store. Each of the plurality of pieces of sub-condition information may be information in which a display style is associated with each of a plurality of reference values defined by the number of staying persons. In the determining, the threshold values may be determined by using reference values included in a piece of sub-condition information corresponding to a location condition of the display target store among the plurality of pieces of sub-condition information.

The number of visitors of a store may depend on the location condition such as location in a busy street or location in a business area. In this case, if the same threshold value is uniformly used for the classification of the numbers of persons staying in the respective areas, it may be difficult to appropriately classify the behaviors of persons staying in the respective areas. Accordingly, in the aspect described above, a threshold value for the display target store is determined by using the sub-condition information corresponding to the location condition of the display target store. Thus, it may be possible to classify the behaviors of persons staying in the respective areas by taking into account the location condition of the display target store.

In the aspect described above, furthermore, the condition information may include a plurality of pieces of sub-condition information, each corresponding to a service provided by the store. Each of the plurality of pieces of sub-condition information may be information in which a display style is associated with each of a plurality of reference values defined by the number of staying persons. In the determining, the threshold values may be determined by using reference values included in a piece of sub-condition information corresponding to a service provided by the display target store among the plurality of pieces of sub-condition information.

The number of visitors of a store may depend on the content of services such as the presence or absence of parking and the store size store. In this case, if the same threshold value is uniformly used for the classification of the numbers of persons staying in the respective areas, it may be difficult to appropriately classify the behaviors of persons staying in the respective areas. Accordingly, in the aspect described above, a threshold value for the display target store is determined by using the sub-condition information corresponding to the content of service provided by the display target store. Thus, it may be possible to classify the behaviors of persons staying in the respective areas by taking into account the content of services provided by the display target store.

In the aspect described above, furthermore, in the calculating, the number of persons, staying in each area within the display target store for the display target period at predetermined time intervals, may be calculated. In the generating, the map screen may be generated at the predetermined time intervals by classifying the numbers of persons staying in each area calculated at the predetermined time intervals by using the determined threshold values, and in the displaying, the map screens may be displayed in chronological order.

In this case, map screens generated at predetermined time intervals within the display target period are displayed in chronological order, allowing the viewer to easily recognize the transition of the number of visitors over the display target period.

In the aspect described above, furthermore, in the calculating, in a case where a plurality of display target stores are selected in the selecting, the numbers of persons, for each area, staying in the plurality of display target stores. In the determining, a plurality of threshold values, corresponding to the plurality of display target stores, may be determined. In the classifying, the calculated numbers of persons, staying in the plurality of display target stores for each area, may be classified by using corresponding threshold values among the determined plurality of threshold values. In the generating, a plurality of map screens, each of which corresponds to one of the plurality of display target stores, may be generated. And in the displaying, the plurality of map screens may be displayed as a list on the display.

In this case, map screens for a plurality of display target stores are displayed as a list, allowing the viewer to easily compare the display target stores in terms of the number of visitors. In addition, each map screen is generated by using a threshold value determined in accordance with the corresponding display target store. Accordingly, it may be possible to appropriately display the behaviors of persons staying in the respective areas.

In the aspect described above, furthermore, the display method may further include accepting instructions to select one of the plurality of map screens displayed as a list on the display; and modifying display styles on the plurality of map screens displayed as a list on the display. In the classifying, the calculated numbers of persons, staying in the plurality of display target stores for each area, may be classified by using a threshold value determined in the determining for the display target store corresponding to the selected map screen. In the modifying, the display styles may be modified by using a result of the classification.

In this case, when one of the map screens displayed as a list is selected, a threshold value determined for the selected map screen is used to modify display styles for the remaining map screens. Accordingly, a user may be able to compare map screens on which the behaviors of staying persons are classified under the same conditions and are displayed.

In the aspect described above, furthermore, at least one of the receiving, the generation of the stay information, the saving, the selecting, the calculating, the determining, the classifying, the generation of the map screen, and the displaying may be performed by a processor.

The embodiment described hereinafter provides a specific example of the present disclosure. The values, shapes, constituent elements, steps, the orders of the steps, etc., given in the following embodiment are illustrative, and are not intended to limit the present disclosure. In addition, among the constituent elements in the following embodiment, a constituent element not recited in any of the independent claims indicating the most generic concept of the present disclosure is described as optional. In addition, every embodiment disclosed herein may be combined with every other embodiment of the present disclosure.

An embodiment of the present disclosure will be described hereinafter with reference to the drawings.

A stay information display system according to an embodiment of the present disclosure divides a department within a store such as a convenience store, a supermarket, or a department store into a plurality of areas in a layout diagram illustrating the layout of the department and displays a map screen on which the customer's staying behavior in each area is mapped onto the layout diagram.

The stay information display system is available in a system that collects information regarding the behavior of customers in a store, analyzes the activities of the customers in a department, and displays an analysis result on a display. The stay information display system may help identify customer interest in a particular shelf or product item and the behavioral tendency of the customers in the store by using the analysis result, so that customer interest and behavioral tendency can be used for stocking product items for sale, creating sales plans, developing the layout of the department, and so forth. The stay information display system is also available in a system for the analysis of the activities of people in a location other than a department within a store, such as in a public facility or in a hospital. In the following, the presentation of the customer's staying behavior in a department within a store will be described in detail.

In the stay information display system, the customer's staying behavior in each area within a store is displayed in a layout diagram by using a display style (such as a color or a pattern) in accordance with the customer's staying behavior. Accordingly, a map screen indicating a layout diagram in which the respective areas within the store are distinguished by using different display styles in accordance with the customer's staying behaviors in the areas is presented to a viewer.

In the stay information display system, furthermore, threshold values used for distinguishing of the areas based on the customer's staying behaviors are not fixed, and appropriate threshold values are determined in accordance with the feature of the display target store, a display target period, and so forth. Accordingly, the customer's staying behavior in each area within a store may be appropriately presented.

### 1.1 Areas in Store

The term “areas”, as used herein, will now be described with reference to the drawings.

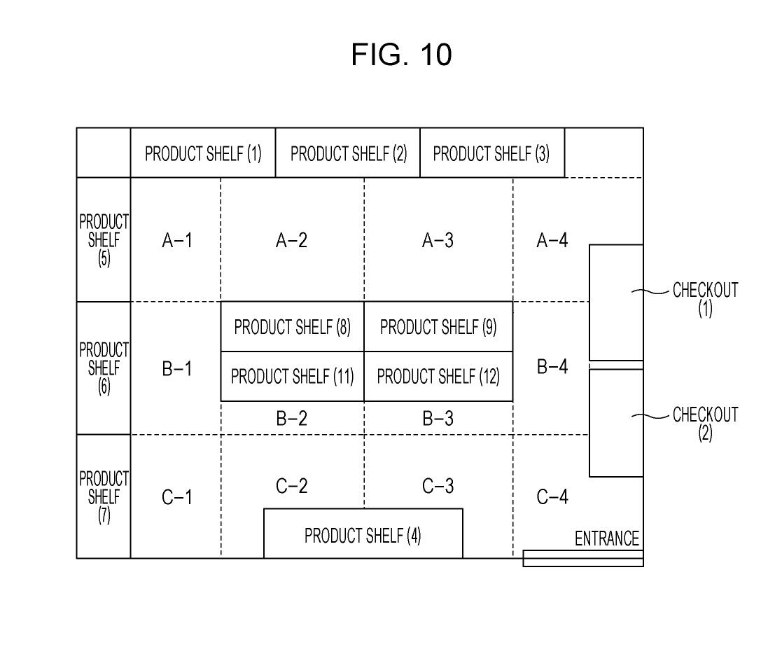

FIG. 10 is a store layout diagram in which a department within a store is divided into a plurality of areas. In the layout diagram in FIG. 10, the following facilities are illustrated. An entrance of the store is located in a lower right portion of the layout diagram. Three product shelves (1) to (3) are aligned along the upper side of the layout diagram, and three product shelves (5) to (7) are aligned along the left side of the layout diagram. A product shelf (4) is located in the center of the lower side of the layout diagram, and four product shelves (8), (9), (11), and (12) are arranged in a center of the layout diagram in a 2×2 array. Two checkout stands (1) and (2) are located in the center of the right side of the layout diagram.

In the layout diagram, furthermore, the department within the store is divided into three partitions vertically and four partitions horizontally. That is, 12 partitioned areas are set. The 12 areas are marked with A to C in the vertical columns for distinguishing purposes, and are marked with 1 to 4 in the horizontal rows for distinguishing purposes. Accordingly, the 12 areas are marked with A-1 to A-4, B-1 to B-4, and C-1 to C-4 for distinguishing purposes. In the example illustrated in FIG. 10, the three areas A-1, B-1, and C-1 in the first column are formed to have substantially the same size, and the remaining nine areas A-2 to A-4, B-2 to B-4, and C-2 to C-4 are formed to have substantially the same size.

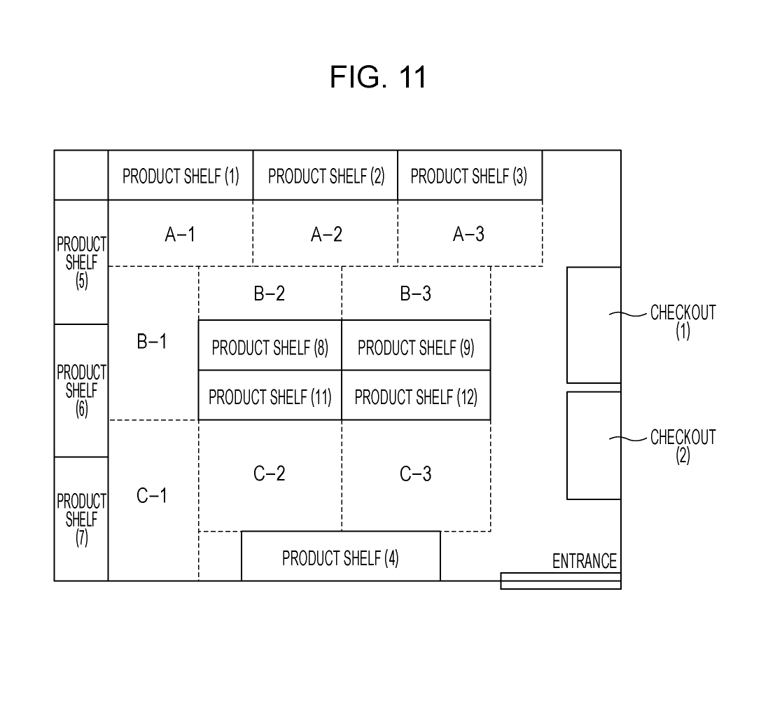

FIG. 11 is a diagram illustrating another example of a store layout diagram in which a department within a store is divided into a plurality of areas. In FIG. 11, the layout of the department within the store is the same as that in FIG. 10. In FIG. 11, the areas are set in a region other than the region where the product shelves are located, in accordance with the positions of the product shelves. Specifically, the areas A-1 to A-3 are formed so that the horizontal lengths of the areas A-1 to A-3 are equal to the horizontal lengths of the product shelves (1) to (3), respectively, the areas B-2 and B-3 are formed so that the horizontal lengths of the areas B-2 and B-3 are equal to the horizontal lengths of the product shelve (8) and (9), respectively, and the areas C-2 and C-3 are formed so that the horizontal lengths of the areas C-2 and C-3 are equal to the horizontal lengths of the product shelves (11) and (12), respectively. The areas B-1 and C-1 are bordered at the lower side of the product shelf (11). In FIG. 11, areas are set in accordance with the product shelves, thus helping understand customer interest in a particular product shelf or product item in more detail.

### 1.2 Configuration of Stay Information Display System

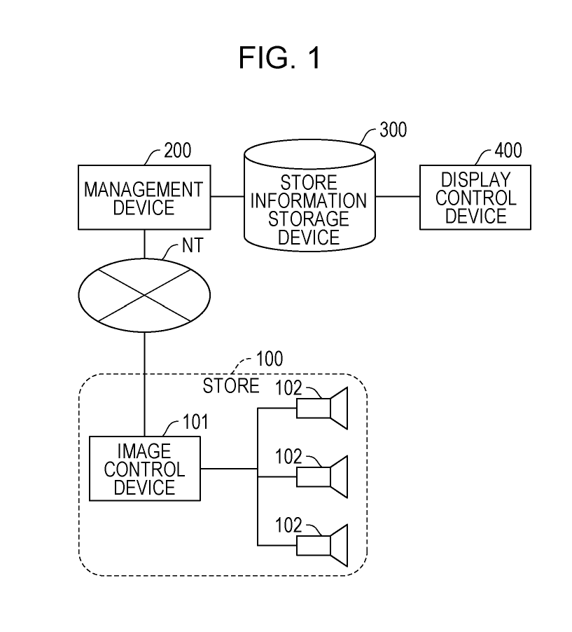

FIG. 1 is a diagram illustrating an example configuration of the stay information display system according to this embodiment. The stay information display system illustrated in FIG. 1 includes an image control device 101, a plurality of camera devices 102, a management device 200, a store information storage device 300 (an example of a storage device), and a display control device 400.

The plurality of camera devices 102 and the image control device 101 are installed in a store 100. The store 100 may be a retail outlet, such as a supermarket, a home improvement store, a convenience store, a department store, a grocery store, and a mart, for illustrative but not limitative purposes. The store 100 may be a facility which people enter and exit, such as a hospital, a city hall, or a station, and may be any facility in which there is a need for analysis of the staying behavior of people.

The management device 200, the store information storage device 300, and the display control device 400 are installed in, for example, a facility that manages the store 100. For example, in a case where the store 100 is a retail outlet, the management device 200, the store information storage device 300, and the display control device 400 may be installed in a headquarters building of a company to which the retail outlet belongs or in a building of an information processing center. The management device 200, the store information storage device 300, and the display control device 400 are connected via, for example, a local area network (LAN) so as to be capable of communicating with one another.

The image control device 101 and the management device 200 are connected via a network NT. The network NT may be, for example, but is not limited to, the Internet. The network NT may be a private line owned by a company to which the store belongs. The image control device 101 and the management device 200 communicate with each other using a communication protocol such as Transmission Control Protocol/Internet Protocol (TCP/IP).

Each of the camera devices 102 is mounted on the ceiling or wall surface or the like in the store 100 so that, for example, the angle of view of the camera device 102 may include at least the floor of the store 100. Each of the camera devices 102 captures an image of a person or persons present in the store 100. Each of the camera devices 102 may be, for example, a video camera that acquires video data at a predetermined frame rate.

The image control device 101 includes, for example, an image processing processor for processing video data captured by the camera devices 102, and a communication processor for connecting the image control device 101 to the network NT. The image control device 101 receives video data captured by the camera devices 102. Then, the image control device 101 generates state information from the received video data, and transmits the state information to the management device 200 via the network NT. The state information may be person detection data.

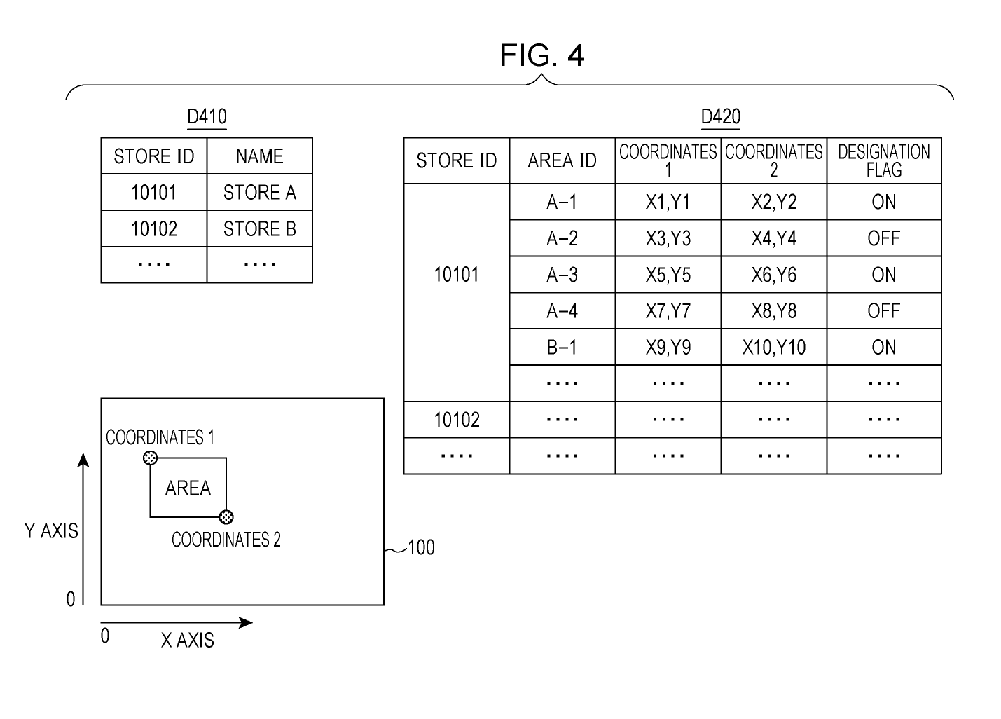

The image control device 101 performs person detection using the video data. Upon detecting a person who is not a store employee, the image control device 101 generates, as state information, person detection data including a location (coordinates) at which the person stays in the store 100 (hereinafter referred to as the “staying location”), and the date and time at which the person stays in the store 100 (hereinafter referred to as the “staying date and time”). The staying location may be represented by using, for example, two-dimensional coordinate data that is defined by a two-dimensional coordinate space defined by two orthogonal axes on the ground in the store 100 with respect to the origin at a certain position on the ground. For example, in the lower left portion of FIG. 4, a staying location is defined by a two-dimensional coordinate space with its origin at the lower left vertex of the layout of the store 100, the Y axis as vertical, and the X axis as horizontal. In addition, the staying location included in the state information is associated with a customer ID assigned to a customer when the customer has been detected by the image control device 101.

A process for detecting a staying location will be described hereinafter using, as an example, the capturing of images of a person diagonally downward using the camera devices 102 when the camera devices 102 are installed in an upper portion of the wall of the store 100. In the following description, therefore, the longitudinal direction (or height direction) of the person in the video data corresponds to the vertical direction.

If the installation positions of the camera devices 102, the optical axes of the camera devices 102, and the magnifications of the camera devices 102 are known, the positions of objects on the floor of the store 100 that appears on an image based on the video data captured by the camera devices 102 correspond to the actual positions of the objects on the floor of the store 100 in a one-to-one relationship. In addition, if the position of the top of the person's head that appears on an image based on the video data is determined, it is possible to identify the position of the person's toes on the image based on the video data from the position of the top of the person's head.

Thus, first, the image control device 101 extracts the portion of the person's head from an image based on the video data. One example of the method for extracting the portion of the person's head may be to extract a silhouette of the person's head by applying an edge extraction process or the like to the video data. Then, the image control device 101 extracts a peak position of the extracted head portion as the position of the top of the person's head. Then, the image control device 101 subtracts a length corresponding to a general human height in the image based on the video data from the extracted position of the top of the person's head in the vertical direction in the image based on the video data. Then, the image control device 101 calculates the position obtained as a result of subtraction as the position of the person's toes on the video data. Then, the image control device 101 identifies the actual position on the floor corresponding to the calculated position of the person's toes on the image based on the video data, and detects the identified position on the floor as a staying location.

The determination as to whether or not a person appearing on an image based on the video data is a store employee of the store 100 may be based on the analysis of information on the color of the clothes of the person by using the video data when, for example, store employees of the store 100 are wearing uniforms. Thus, the image control device 101 extracts a region having a certain size that is almost equal to the size of the person from the top of their head to their toes, which is detected through the process described above, from the video data, and extracts the feature value of the color from the extracted region. Examples of the feature value of the color may include a histogram of color components. If the similarity of the extracted feature value of the color to a known feature value of the color of the uniforms of the store employees is greater than or equal to a specified value, the image control device 101 determines that the person being processed is a store employee. If the similarity is less than the specified value, the image control device 101 determines that the person being processed is a customer.

Then, when the image control device 101 determines that a particular person is a customer, the image control device 101 assigns a customer ID to the customer. Thereafter, the image control device 101 tracks staying locations of the customer for a certain period (for example, 10 seconds) by using the video data, and records the tracked staying locations in chronological order in association with the customer ID. At the time of the transmission of state information, the image control device 101 generates state information including staying locations for each customer ID, which have been recorded but have not yet been transmitted, and transmits the state information to the management device 200.

The determination as to whether or not a person appearing on an image based on the video data is a store employee of the store 100 may also be based on, for example, radio frequency identification (RFID) tags. For example, it is assumed that RFID tags are arranged over an entire surface of the floor of the store 100 at a predetermined density. It is also assumed that store employees are wearing name tags or mobile terminals having RFID readers. It is further assumed that the image control device 101 has stored in advance therein tag management information and reader management information. In the tag management information, the position of each RFID tag in the store 100 is associated with the tag ID of the RFID tag. In the reader management information, the ID of each store employee is associated with the reader ID of the RFID reader associated with the store employee.

In this case, upon receipt of a signal transmitted from an RFID tag, an RFID reader transmits a signal including the tag ID of the RFID tag, which is included in the received signal, and also including the reader ID of the RFID reader to the image control device 101. Upon receipt of the signal, the image control device 101 refers to the reader management information and identifies the ID of the store employee associated with the reader ID of the RFID reader, which is included in the received signal, thereby identifying the store employee. The image control device 101 also refers to the tag management information and identifies the position of the RFID tag in the store 100, which is associated with the tag ID included in the received signal. Then, the image control device 101 detects the identified position in the store 100 as a staying location of the identified store employee. If a staying location of the person identified by the process described above from the video data matches a staying location of a store employee detected at the same timing, the image control device 101 determines that the identified person is a store employee, or otherwise, determines that the identified person is a customer.

In the foregoing description, by way of example, the camera devices 102 are mounted on the wall surface in the store 100. The camera devices 102 may be mounted on the ceiling surface. In this case, for example, a staying location of a person is detected by the following process: In a case where the camera devices 102 are ceiling-mounted, the camera devices 102 capture images of the store 100 looking down from above. Accordingly, video data obtained by the camera devices 102 represents a video image on which the person's head appears to be superimposed on the floor of the store 100, and the position of the person's head appearing on the image based on the video data directly indicates a staying location of the person in the store 100. If the installation positions and the angles of view of the camera devices 102 are known, the positions of objects on the floor of the store 100 that appears on an image based on the video data correspond to the actual positions of the objects on the floor of the store 100 in a one-to-one relationship. Thus, first, the image control device 101 extracts the position of the person's head from an image based on the video data. Then, the image control device 101 determines the actual position corresponding to the extracted head position in the store 100, and detects the determined position as a staying location of the person.

The state information may also include, instead of a staying location of a person in the store 100, camera related information such as the identifier, installation position, and capture direction (or optical axis direction) of a camera device 102 that has captured the image. In this case, the position of a person in the store 100 is calculated from the camera related information described above. When an image of a person is captured from above, the clothes of the person do not appear in the image based on video data. Thus, it is difficult to determine whether the person is a store employee or a customer, by using the video data. Accordingly, in a case where the camera devices 102 are ceiling-mounted, the image control device 101 may use the RFID-based technique described above to determine whether a person whose staying location has been detected from the video data is a store employee or a customer. Also if the store 100 is a store whose employees are not wearing uniforms, the RFID-based technique described above may be used to determine a person whose staying location has been detected from the video data is a store employee or a customer.

A staying location of a person may also be calculated using measurement data obtained by measurement using sensors rather than the camera devices 102. Examples of the sensors may include a variety of sensors such as a temperature image sensor that acquires a temperature image that is a two-dimensional representation of the distribution of temperatures, and an optical sensor. A staying location of a person may also be calculated using audio input from a microphone. Laser range scanners may be installed on product shelves in the store 100. In this case, by using measurement data obtained by measurement using a laser range scanner, the stay information display system can acquire information such as whether or not a customer has tried to reach the shelf, and may thus acquire more detailed customer data.

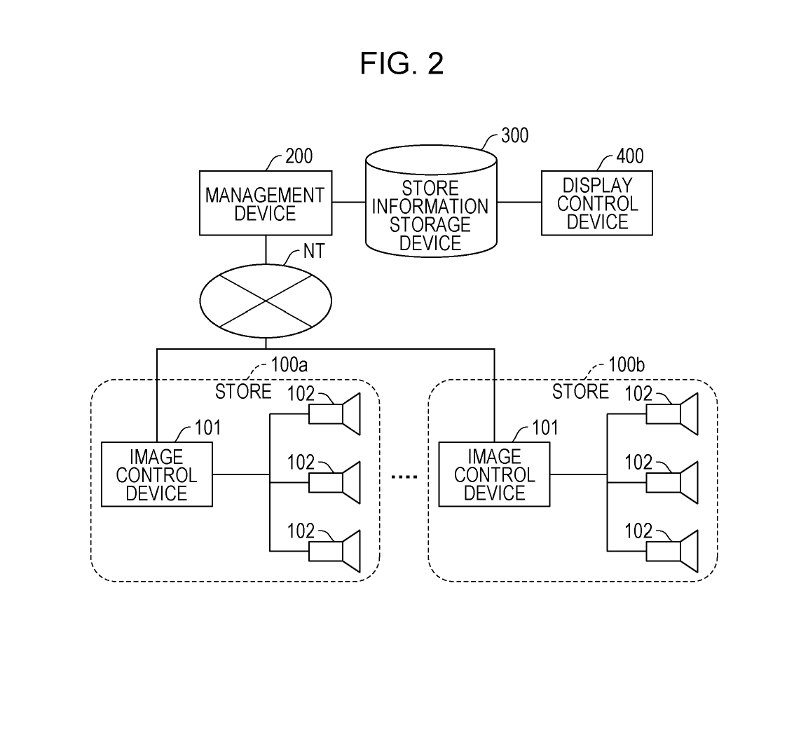

The management device 200 receives the state information transmitted from the image control device 101. The management device 200 generates stay information from the received state information, and saves the stay information in the store information storage device 300. The details of the stay information will be described below. In FIG. 1, a single store (i.e., the store 100) is illustrated. As illustrated in FIG. 2, the stay information display system may also simultaneously manages a plurality of stores 100a and 100b. The management device 200 associates the received state information with a store from which the state information was transmitted to generate stay information, and saves the stay information in the store information storage device 300.

The store information storage device 300 stores store information on all the stores that the management device 200 manages. The store information includes store list information, area setting information, and stay information. The stay information is sequentially updated when the management device 200 receives state information from each store.

The display control device 400 selects a display target store and a display target period in accordance with instructions of a viewer, and acquires stay information associated with the selected display target store and display target period from the store information storage device 300. The display control device 400 classifies the numbers of customers staying in respective areas within a store by using the acquired stay information, and displays a map screen including a store layout diagram in which the respective areas are displayed using display styles in accordance with the classification results. The map screen provides display of each of the areas within the store by using a display style among a plurality of display styles (such as colors or patterns) in accordance with the number of customers staying in each area. Accordingly, it may be possible to provide a viewer with a view of the customer's staying behavior in each area. The view allows the viewer to instantly recognize the customer's staying behavior in each area within the display target store for the display target period. Here, the display control device 400 classifies the numbers of persons staying in respective areas using threshold values. In this case, the same threshold value is not uniformly used, but rather the threshold values are determined in accordance with the characteristics of the display target store, the display target period, and so forth. Thus, the stay information display system may appropriately classify the numbers of persons staying in respective areas by using threshold values determined in accordance with the display target store and the display target period.

In the manner described above, the stay information display system collects stay information on stays of customers in each store, and displays a map screen on which the customer's staying behavior in each area within the store is presented in an easy-to-understand way.

### 1.3 Information Saved in Store Information Storage Device 300

The store information storage device 300 stores store information on all the stores that the management device 200 manages. The store information includes store list information, area setting information, and stay information. FIG. 4 is a diagram illustrating an example of store list information D410 and area setting information D420.

### (1) Store List Information

The store list information D410 is information in which a list of stores to be managed is registered, and has a data structure in which one record is assigned to each of the stores to be managed. The store list information D410 stores a “store ID” and a “name” in associated with each other. The “store ID” is an identifier for uniquely identifying each store. The “name” is a name assigned to the store.

The store list information D410 may store address or location information on each store. The location information includes, for example, location in a business area, location in a residential area, spatial proximity to high schools, spatial proximity to technical schools, colleges, or universities, spatial proximity to highways, spatial proximity to railway stations, spatial proximity to bus stops or terminals, and spatial proximity to competitors.

The store list information D410 may also store information relating to services and product items for sale in each store. The information relating to services and product items for sale includes, for example, the store size, the presence or absence of parking, the number of vehicles that can be parked, the handling of liquor, the handling of drugs, the handling of perishables, the presence or absence of eat-in areas, and the handling of delivery services.

The store list information D410 may also store information indicating whether or not each store is selectable as a target for which the customer's staying behavior is to be displayed. In this case, when the viewer selects a display target store, only the stores set to be selectable are displayed in list form.

The stay information display system may have a function to set a plurality of stores as a group. In this case, the store list information D410 may store information indicating which group each store belongs to.

### (2) Area Setting Information

The area setting information D420 includes a “store ID”, an “area ID”, an “area location (coordinates 1 and coordinates 2)”, and a “designation flag”. The “store ID” corresponds to the “store ID” in the store list information D410. The “area ID” is an identifier of each of a plurality of areas set in each store.

It is assumed that the store 100 having the store ID “10101” is divided into the 12 areas illustrated in FIG. 10. Thus, in the area setting information D420, the store ID “10101” is associated with the area IDs of the 12 areas, namely, the area IDs “A-1”, “A-2”, “A-3”, “A-4”, “B-1”, “B-2”, “B-3”, “B-4”, “C-1”, “C-2”, “C-3”, and “C-4”.

The “area location” indicates the location of each area. In the illustrated example, the “area location” is defined by the positions of two points of each area, that is, “coordinates 1” and “coordinates 2”. In the lower left portion of FIG. 4, the coordinates 1 and the coordinates 2 are illustrated. In the illustrated example, the lower left vertex of the layout diagram is at the origin, and coordinates (0, 0) are set. In the illustrated example, furthermore, the layout diagram is rectangular with the Y axis as vertical and the X axis as horizontal. Accordingly, the position of each object in the store 100 is represented by two-dimensional coordinate data (X, Y). While the lower left vertex of the layout diagram is at the origin in the illustrated example, the upper left, upper right, or lower right vertex of the layout diagram may be at the origin.

In the illustrated example, furthermore, the area has a rectangular shape with the coordinates 1 indicating the upper left vertex of the area and the coordinates 2 indicating the lower right vertex of the area. That is, the area is defined as a rectangular region defined by the coordinates 1 and the coordinates 2. In the illustrated example, the coordinates 1 indicate the upper left vertex of the area and the coordinates 2 indicate the lower right vertex of the area, for illustrative but not limitative purposes. The coordinates 1 may indicate the upper right vertex of the area and the coordinates 2 may indicate the lower left vertex of the area.

In the area setting information D420, the “designation flag” is information indicating whether or not each area is selectable as a target for which the customer's staying behavior is to be displayed. An area whose “designation flag” is “ON” is a “designated area” that is selectable as a target for which the customer's staying behavior is to be displayed. On the other hand, an area whose “designation flag” is “OFF” is an “out-of-target area” that is not selectable as a target for which the customer's staying behavior is to be displayed.

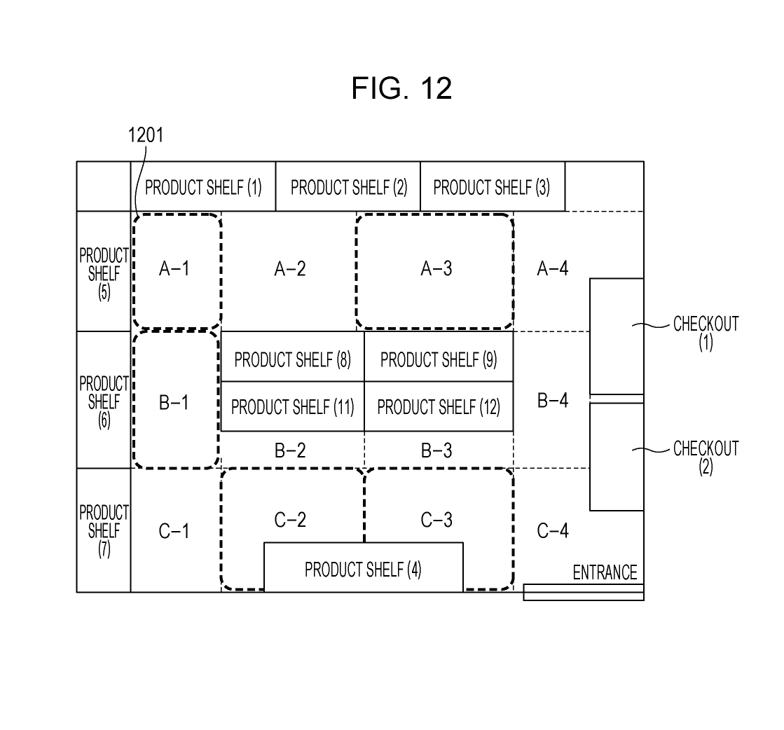

In the illustrated example, the areas A-1, A-3, and B-1 are set as “designated areas”. FIG. 12 is a diagram illustrating an example of a store map screen on which designated areas are set. In the example illustrated in FIG. 12, the designated areas are surrounded by thick broken lines 1201. In the illustrated example, the areas A-1, A-3, B-1, C-2, and C-3 are surrounded by the thick broken lines 1201 in accordance with the “designation flag” set in the area setting information D420, which indicates that these areas are designated areas.

Surrounding designated areas by the thick broken lines 1201 allows a viewer to easily identify whether or not each area is selectable as a target for which the customer's staying behavior is to be displayed. Here, a display style in which a designated area is indicated by a thick line is used for illustrative purposes only. Any other display style may be used. For example, a designated area and an out-of-target area may be surrounded by lines of different colors. Alternatively, for example, an entire out-of-target area may be displayed in semi-transparent gray to allow the viewer to clearly distinguish the out-of-target area from a designated area.

In a case where each area within a store has a rectangular shape with a fixed size, the position of each area within the store can be determined using only a single coordinate system. In this case, it may be sufficient that the area setting information D420 only stores the coordinates 1.

In a case where each area within a store has a circular shape, the position of each area within the store can be determined once the coordinates of the center and radius of the circle are determined. In this case, it may be sufficient that the area setting information D420 stores the coordinates of centers and radii of the individual areas. In this manner, it may be sufficient that the area setting information D420 stores information from which the position of each area in a layout diagram can be determined when a map screen is displayed.

### (3) Stay Information

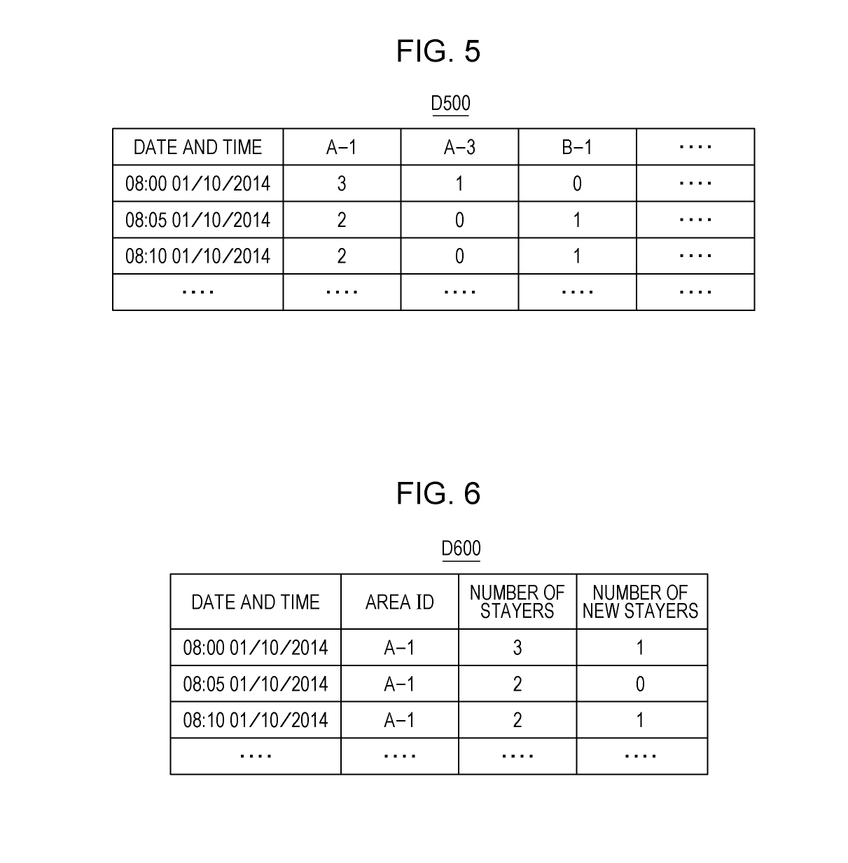

FIG. 5 is a diagram illustrating an example data configuration of stay information D500. The stay information D500 stores the number of customers who stayed in each area and “date and time” indicating the date and time at which the customers stayed in association with each other. Specifically, the stay information D500 has a data structure in which one record is assigned to each “date and time”, and each record contains the numbers of customers staying hereinafter also referred to as “stayers”) in the respective areas at the associated “date and time”.

In FIG. 5, the stay information D500 on the store 100 is illustrated. The example illustrated in FIG. 5 depicts that three and two customers stayed in the area A-1 at 8:00 and 8:05 on Jan. 10, 2014, respectively. In FIG. 5, the numbers of customers who stayed, which are counted at time intervals of five minutes, are stored, by way of example. The time interval may be shorter than five minutes, or may be longer than five minutes. In addition, the time interval may not necessarily be fixed. In this case, for example, the following settings may be used: The time interval during a time period in which a store is crowded is shorter than a standard time interval, the time interval during a time period in which the store is far less crowded or even empty is longer than the standard time interval, and the time interval during the other time period is equal to the standard time interval.

Note that when a particular customer was present in the same location and spent a certain period of time (for example, 10 seconds) or longer, it is determined that the particular customer “stayed”. In this case, the number of stayers is counted up.

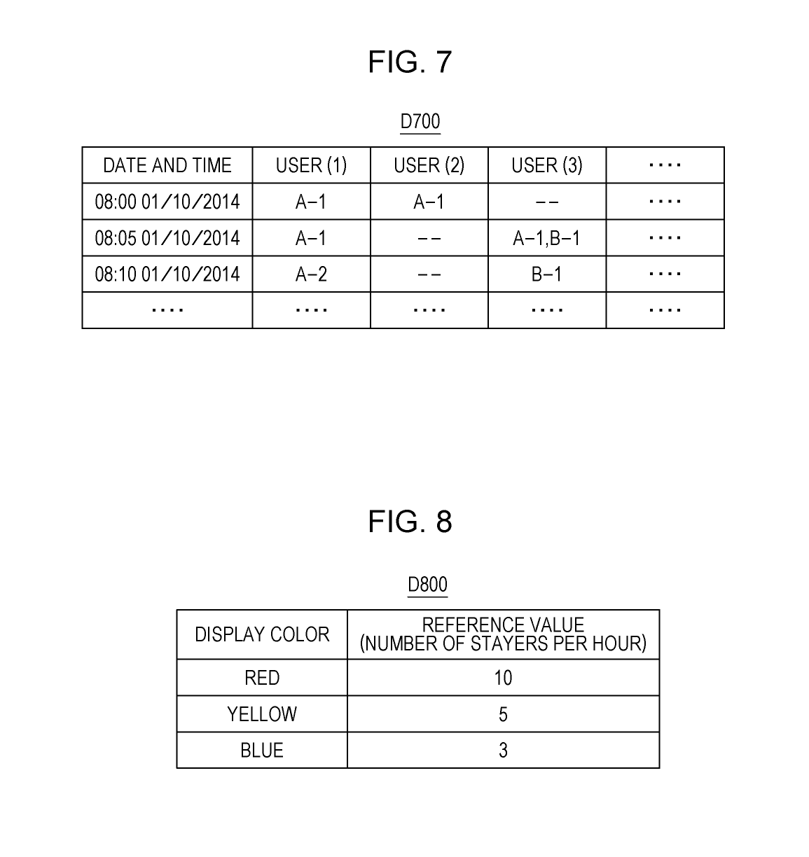

FIG. 6 is a diagram illustrating a data configuration of stay information D600 that is another example of stay information. The stay information D600 stores the number of stayers, which is the number of customers who stayed in each area, the number of new stayers, which is the number of customers who moved to each area from a different location, and date and time in association with one another. The illustrated example depicts that three customers stayed in the area A-1 within the store 100 at 8:00 on Jan. 10, 2014 and that one of the three customers is a new stayer who moved from a different location. In FIG. 6, the numbers of customer stayers, which are counted at time intervals of five minutes, are stored, by way of example. The time interval may be shorter than five minutes, or may be longer than five minutes. In the stay information D600, similarly to the stay information D500, when a particular person was preset in the same location and spent 10 seconds or longer, it is determined that the particular person “stayed”. In this case, the number of stayers is counted up. In the example illustrated in FIG. 6, the number of stayers and the number of new stayers in the area A-1 are illustrated. The stay information D600 also stores the numbers of stayers and the numbers of new stayers in the other areas in a manner similar to that for the area A-1.

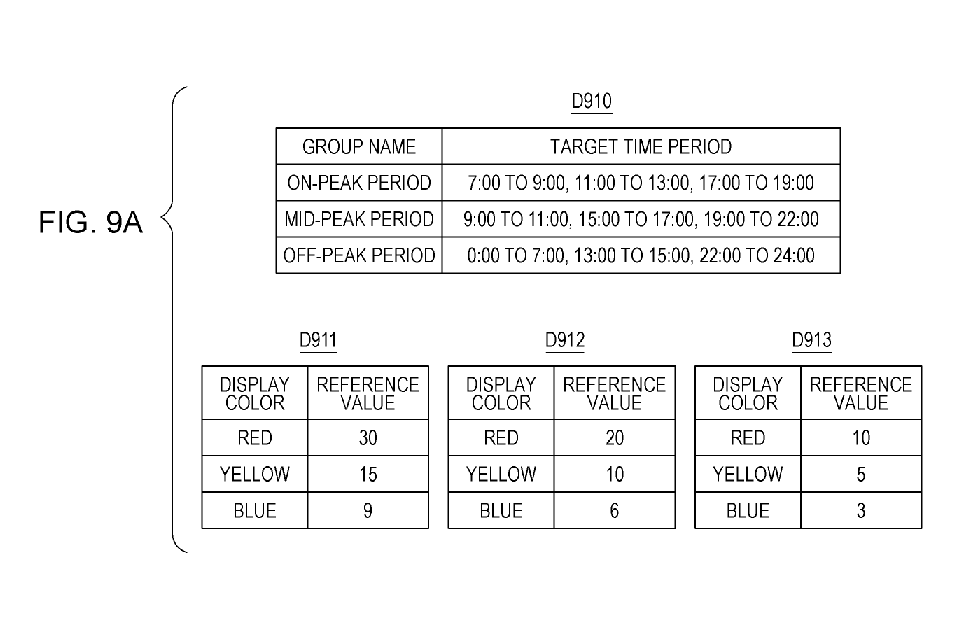

FIG. 7 is a diagram illustrating a data configuration of stay information D700 that is another example of stay information. The stay information D700 stores an area in which each user (or customer) stayed and date and time in association with each other. In the stay information D700, since staying dates and times and staying areas of each customer are stored, tracking the areas in which each customer stayed in chronological order allows the viewer to identify the route of movement of the customer. The example illustrated in FIG. 7 provides a record that a user (1) stayed in the area A-1 at 8:00 and 8:05 on Jan. 10, 2014 and stayed in the area A-2 at 8:10 on Jan. 10, 2014. It is thus found that the user (1) stayed in the area A-1 in the time period from 8:00 to 8:05 on Jan. 10, 2014 and then moved to the area A-2 from the area A-1 by 8:10. In the example illustrated in FIG. 7, there is no record of an area in which a user (3) stayed at 8:00 on Jan. 10, 2014. It is thus found that the user (3) was moving in the store 100 or had not yet visited the store 100 at 8:00. In addition, there is a record that the user (3) stayed in the areas A-1 and A-2 at 8:05 and stayed in the area B-1 at 8:10. It is thus found that the user (3) was slowly moving from the area A-1 to the area B-1 at 8:05, for example, browsing displayed goods, and lingered in the area B-1 at 8:10.

In the stay information D500, the stay information D600, and the stay information D700, areas in which customers stayed are recorded in association with “dates and times”. Alternatively, staying locations of customers may be recorded in association with “dates and times”. In this case, when displaying a map screen, the stay information display system may refer to the area setting information D420 to identify areas in which customers stayed from the staying locations of the customers, which are recorded in the stay information D500, the stay information D600, and the stay information D700, and may calculate the numbers of stayers in the respective areas.

That is, the stay information D500, the stay information D600, and the stay information D700 may store any information from which the number of stayers in each area and the date and time at which the persons stayed can be identified when a map screen is displayed.

### 1.4 Configuration of Management Device 200

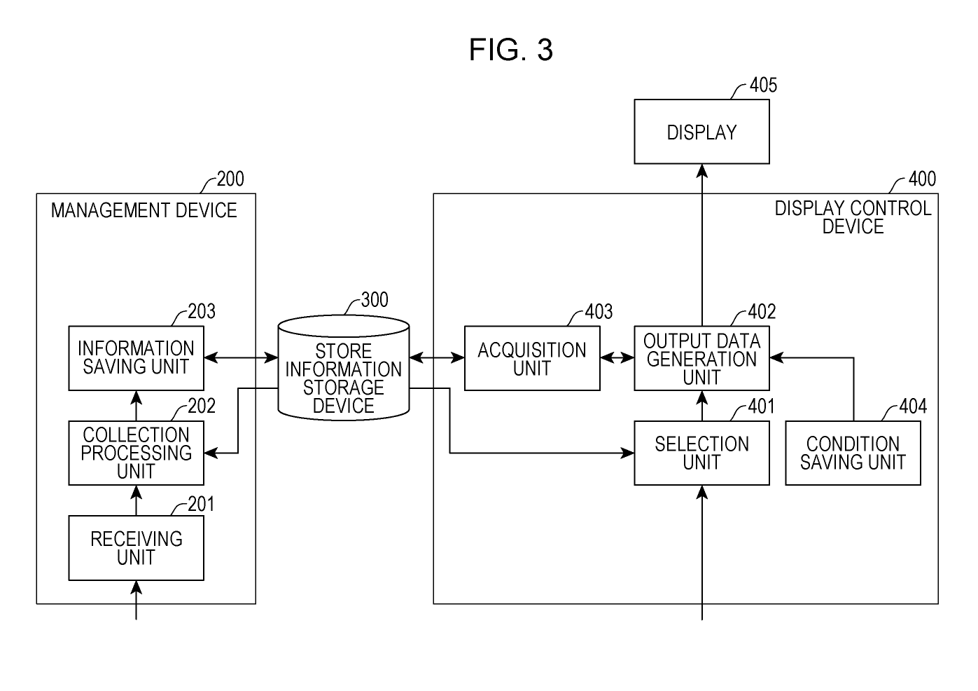

FIG. 3 is a diagram illustrating an example configuration of the management device 200 and the display control device 400 in the stay information display system. The management device 200 includes a receiving unit 201, a collection processing unit 202, and an information saving unit 203.

The receiving unit 201 is formed of, for example, a communication processor for connecting the management device 200 to the network NT, and receives state information transmitted from the image control device 101 in each store. The receiving unit 201 outputs the received state information to the collection processing unit 202 in association with the store ID of the store from which the state information was transmitted.

The collection processing unit 202 generates stay information by using the area setting information D420 stored in the store information storage device 300 and the state information output from the receiving unit 201. The collection processing unit 202 generates any one of the stay information D500, the stay information D600, and the stay information D700 illustrated as an example illustrated in FIG. 5, FIG. 6, and FIG. 7, respectively. In the following, stay information is represented by D500, for convenience of description. Here, staying locations of each customer are recorded in the state information for a certain period (for example, 10 seconds). In addition, it is assumed that the interval at which state information is transmitted is, for example, one day. In this case, the collection processing unit 202 extracts a staying location in which a customer stayed for a certain period of time (for example, 10 seconds) or longer from among the staying locations included in the state information output from the receiving unit 201. Then, the collection processing unit 202 classifies the extracted staying locations by time period. Each time period is defined by the “date and time” in the stay information D500. Then, the collection processing unit 202 refers to the area setting information D420 to identify the areas including the staying locations for each time period, and calculates the numbers of stayers in the respective areas. Then, the collection processing unit 202 stores the numbers of stayers in the respective areas, which are calculated for each time period, in the record of the associated “date and time” in the stay information D500 to generate the stay information D500.

The information saving unit 203 saves the stay information D500 generated by the collection processing unit 202 in the store information storage device 300 in association with the store ID of the store corresponding to the stay information D500. Here, the store information storage device 300 adds new stay information D500 to the existing stay information D500, rather than overwriting the existing stay information D500 with the newly generated stay information D500. That is, the store information storage device 300 adds new stay information D500 without deleting the existing stay information D500. When a predetermined period of time or a predetermined data size is reached, it may be sufficient that the store information storage device 300 deletes records in the stay information D500 in chronological order from the oldest date and time.

The image control device 101 in each store may transmit state information in real time. In this case, the collection processing unit 202 may use the date and time at which the state information was received as the “date and time” in the stay information D500.

The management device 200 may record, as the stay information D500, information in which a detected staying location of a customer and the staying date and time are associated with each other, without using the area setting information D420 stored in the store information storage device 300. In this case, the display control device 400 may count the number of stayers in each area for a display target period from the stay information D500 generated by the management device 200, by using the area setting information D420 stored in the store information storage device 300.

### 1.5 Configuration of Display Control Device 400

The display control device 400 includes a selection unit 401, an output data generation unit 402, an acquisition unit 403, a condition saving unit 404, and a display 405.

The selection unit 401 includes, for example, an operation device that accepts an operation from a viewer, and selects a display target store from among stores recorded in the store list information D410 in the store information storage device 300 in accordance with instructions of the viewer. Further, the selection unit 401 selects a display target period in accordance with instructions of the viewer. The display target period is a period defined by a start date and time and an end date and time. The selection unit 401 outputs a period (display target period) represented by a start date and time and an end date and time and the store ID of the selected store (display target store) to the output data generation unit 402 as display target information. The operation device included in the selection unit 401 may be, for example, a keyboard or a mouse if the display control device 400 is composed of a personal computer, or may be a touch panel if the display control device 400 is composed of a tablet terminal or a smartphone.

The selection unit 401 may simultaneously select a plurality of display target stores. The selection unit 401 may also simultaneously specify a plurality of display target periods. In addition, information indicating a display target store may not necessarily be a store ID, and may be any other information such as a store name. Information indicating a display target store may also be an address indicating a display target district. In this case, all the stores in the district are display target stores.

The output data generation unit 402 receives the display target information, which includes the display target period and the store ID of the display target store, from the selection unit 401, and starts processing. The output data generation unit 402 notifies the acquisition unit 403 of the display target information, and instructs the acquisition unit 403 to acquire the stay information D500 associated with the display target store and the display target period. The output data generation unit 402 refers to the condition information saved in the condition saving unit 404, and determines threshold values in accordance with at least any one of the display target store and display target period indicated by the display target information. The threshold values are used to classify the numbers of stayers in respective areas. The details of the determination of threshold values using the output data generation unit 402 will be described below in the description of the condition saving unit 404.

Upon receipt of information regarding the numbers of stayers in the respective areas within the display target store from the acquisition unit 403, the output data generation unit 402 classifies the numbers of customers staying in the respective areas by using the determined threshold values. Then, the output data generation unit 402 determines a display style for each area from among a plurality of display styles (such as colors or patterns) in accordance with the classification result, and displays on the display 405 a map screen on which the customer's staying behaviors in the respective areas are mapped onto the layout diagram by using the determined display styles.

The acquisition unit 403 receives the display target information from the output data generation unit 402, and acquires the stay information D500 associated with the display target store and the display target period from the store information storage device 300. The acquisition unit 403 counts the number of stayers in each area within the display target store by using the acquired stay information D500, and outputs the count result to the output data generation unit 402.

The process performed by the acquisition unit 403 will be described using the stay information D500 in FIG. 5 as an example. It is assumed that the display target store is the store 100 and the display target period is 8:00 to 8:10 on Jan. 10, 2014. In this case, the acquisition unit 403 acquires stay information D500 recorded in three records labeled “08:00 01/10/2014”, “08:05 01/10/2014”, and “08:10 01/10/2014” from the store information storage device 300. Then, the acquisition unit 403 counts the number of stayers in the area A-1 within the store 100, and obtains four persons (two at 8:05+two at 8:10). Note that the stay information at the time of 8:00 on Jan. 10, 2014 is excluded from the calculation because it is stay information for the period from 7:55 to 8:00, which indicates stay information for a period not included in the 10 minute period from 8:00 to 8:10.

The condition saving unit 404 saves condition information that specifies the condition for determining threshold values used to classify the numbers of stayers in the respective areas.

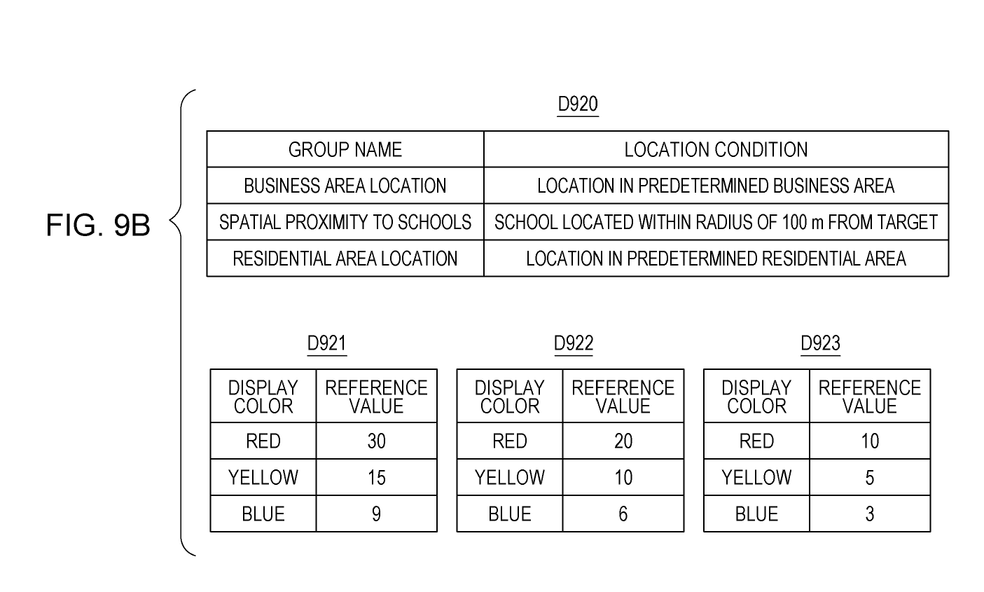

FIG. 8 is a diagram illustrating an example of condition information D800. The condition information D800 is information in which a “display color” and a “reference value” are associated with each other. In the example illustrated in FIG. 8, the number of stayers per hour is used as a reference value. Here, the “display color” is an example of a display style.

If the duration indicated by the display target period is one hour, the output data generation unit 402 determines the reference values in the condition information D800 directly as threshold values. In this case, the output data generation unit 402 classifies the numbers of stayers in the respective areas within the display target store so that “red” is used as the “display color” for an area in which the number of stayers is greater than or equal to 10, “yellow” as the “display color” for an area in which the number of stayers is greater than or equal to 5 and less than or equal to 9, “blue” as the “display color” for an area in which the number of stayers is greater than or equal to 3 and less than or equal to 4, and “colorless” as the “display color” for an area in which the number of stayers is less than or equal to 2. In this manner, the output data generation unit 402 performs the process described above using the condition information D800 on the respective areas within the display target store, and classifies the numbers of stayers in the respective areas. Then, the output data generation unit 402 determines the display colors for the respective areas in accordance with the classification results.

If the duration indicated by the display target period is not one hour, the output data generation unit 402 determines threshold values by correcting the reference values to fit the period length. For example, if the duration indicated by the display target period is 30 minutes, the output data generation unit 402 determines values given by “the reference values in the condition information×1/2” as threshold values. In this case, the output data generation unit 402 classifies the numbers of stayers in the respective areas within the display target store so that “red” is used as the “display color” for an area in which the number of stayers is greater than or equal to 5, “yellow” as the “display color” for an area in which the number of stayers is greater than or equal to 3 and less than or equal to 4, “blue” as the “display color” for an area in which the number of stayers is 2, and “colorless” as the “display color” for an area in which the number of stayers is less than or equal to 1.

For example, if the duration indicated by the display target period is three hours, the output data generation unit 402 determines values given by “the reference values in the condition information×3” as threshold values. In this case, the output data generation unit 402 classifies the numbers of stayers in the respective area in the display target store so that “red” is used as the “display color” for an area in which the number of stayers is greater than or equal to 30, “yellow” as the “display color” for an area in which the number of stayers is greater than or equal to 15 and less than or equal to 29, “blue” as the “display color” for an area in which the number of stayers is greater than or equal to 9 and less than or equal to 14, and “colorless” as the “display color” for an area in which the number of stayers is less than or equal to 8.

The longer the duration indicated by the display target period, the larger the cumulative number of customers who entered each area, and therefore, the larger the number of stayers in each area to be displayed. For this reason, if a fixed threshold value is uniformly used regardless of the length of the display target period, all the areas might be displayed in the same color. To avoid this situation, the display control device 400 according to this embodiment determines appropriate threshold values in accordance with the duration indicated by the display target period, and classifies the numbers of stayers in the respective areas by using the threshold values. Accordingly, the display control device 400 may provide the viewer with a more appropriate presentation of the customer's staying behavior in each area within a store.

In the foregoing description, a display color is used as the display style, for illustrative purposes only. Any other display style such as a pattern may be used. In a case where a pattern is used, the condition information D800 may have any of the following display styles, by way of example: The larger the reference value, the higher the density of dots. The larger the reference value, the higher the density of a layer image of semi-transparent gray. The larger the reference value, the higher the density of hatching lines.

In the condition information D800, furthermore, the number of stayers per hour is used as a reference value, for illustrative purposes only. The number of stayers per any unit time other than per hour, such as 30 minutes, 10 minutes, or 2 hours, may be used. In the condition information D800, furthermore, the numbers of stayers are classified using a display style of three colors, that is, red, yellow, and blue, for illustrative purposes only. The numbers of stayers may be classified using a predetermined number of colors more than three colors, or may be classified using two colors. In the condition information D800, furthermore, red, yellow, and blue are used as display colors, for illustrative purposes only. Any color that allows the number of persons staying in each area to be appropriately classified and displayed may be used. For example, in the condition information D800, orange, green, and purple may be used for the reference values of 10, 5, and 3, respectively.

In addition, when the respective areas are displayed in display colors corresponding to the classification results, it may be sufficient that the output data generation unit 402 creates semi-transparent layer images having the display colors determined in accordance with the classification results, and superimposes each of the layer images on the corresponding one of the areas for display. This may prevent existing information in the layout diagram from being solidly filled with a display color.

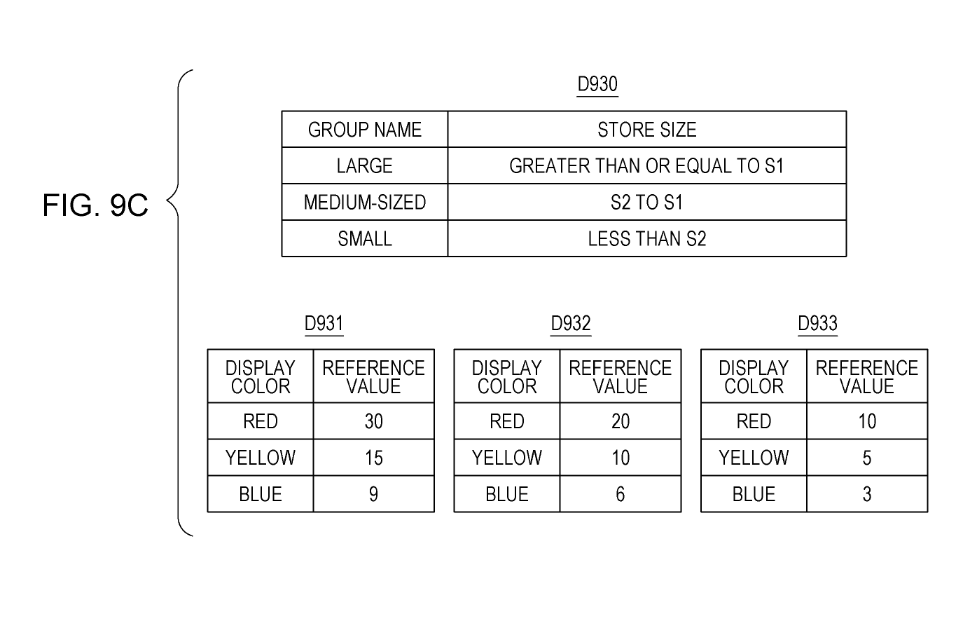

FIG. 9A is a diagram illustrating a data configuration of condition information D910 that is another example of condition information. The condition information D910 includes a plurality of (here, three) pieces of sub-condition information each corresponding to one of a plurality of time periods, namely, sub-condition information D911, sub-condition information D912, and sub-condition information D913. In the sub-condition information D911, the sub-condition information D912, and the sub-condition information D913, a display color and a reference value are associated with each other.

Specifically, the condition information D910 includes a “group name” and a “target time period”. There are three groups indicating an on-peak period, a mid-peak period, and an off-peak period. Thus, an “on-peak period”, a “mid-peak period”, and an “off-peak period” are stored as “group names”. The “target time period” contains time periods used to determine which group out of the “on-peak period”, “mid-peak period”, and “off-peak period” groups the display target period belongs to. For example, if the display target period is in any of “7:00 to 9:00”, “11:00 to 13:00”, and “17:00 to 19:00”, it is determined that the display target period is in the “on-peak period” group.

The sub-condition information D911, the sub-condition information D912, and the sub-condition information D913 each include a “display color” and a “reference value”, and have the same data configuration as the condition information D800. That is, the reference value represents the number of stayers per hour. Here, in daily business hours for a store, the “on-peak period” group indicates a time period during which the number of customers who visit the store is large, the “off-peak period” group indicates a time period during which the number of customer who visit the store is small, and the “mid-peak period” group indicates a time period during which the number of customers who visit the store is smaller than that during the “on-peak period” group but larger than that during the “off-peak period” group.

Accordingly, in the sub-condition information D911 indicating the “on-peak period” group, reference values that are larger than those for the “mid-peak period” group are used, and in the sub-condition information D913 indicating the “off-peak period” group, reference values that are smaller than those for the “mid-peak period” group are used.

For example, if the display target period is from 8:00 to 9:00, the output data generation unit 402 determines that the time group is the “on-peak period” group, and selects the sub-condition information D911. Then, the output data generation unit 402 classifies the numbers of stayers in the respective areas within the display target store so that “red” is used for an area in which the number of stayers is greater than or equal to 30, “yellow” is used for an area in which the number of stayers is greater than or equal to 15 and less than or equal to 29, “blue” is used for an area in witch the number of stayers is greater than or equal to 9 and less than or equal to 14, and “colorless” is used for an area in which the number of stayers is less than or equal to 8.

For example, if the display target period is from 8:00 to 10:00, the output data generation unit 402 determines that the time group from 8:00 to 9:00 is the “on-peak period” group and the time group from 9:00 to 10:00 is the “mid-peak period” group, and selects the sub-condition information D911 and the sub-condition information D912. Then, the output data generation unit 402 determines values given by “(the reference values for the on-peak period+the reference values for the mid-peak period)×½” as threshold values using the sub-condition information D911 indicating the “on-peak period” group and the sub-condition information D912 indicating the “mid-peak period” group. In this case, the output data generation unit 402 classifies the numbers of stayers in the respective areas within the display target store so that “red” is used as the “display color” for an area in which the number of stayers is greater than or equal to 25, “yellow” as the “display color” for an area in which the number of stayers is greater than or equal to 13 and less than or equal to 24, “blue” as the “display color” for an area in which the number of stayers is greater than or equal to 8 and less than or equal to 12, and “colorless” as the “display color” for an area in which the number of stayers is less than or equal to 7.

Here, when the display target period extends over a plurality of time groups, the output data generation unit 402 calculates an average value of reference values for the respective time groups to obtain a threshold value, for illustrative purposes only. For example, the output data generation unit 402 may calculate a weighted average value of reference values for the respective time groups to obtain a threshold value in accordance with the proportion of each of the time groups in the display target period.

For example, if the display target period is from 9:00 to 12:00, the ratio of the “on-peak period” group to the “mid-peak period” group in the display target period is 1:2. In this case, the output data generation unit 402 may determine values given by “(the reference values for the on-peak period)×⅓+(the reference values for the mid-peak period)×⅔” as threshold values.

In addition, in a case where threshold values are determined by using the condition information D910 illustrated in FIG. 9A, threshold values may be determined by correcting reference values in accordance with the duration indicated by the display target period. For example, if the display target period is from 7:00 to 9:00, the output data generation unit 402 may determine values obtained by multiplying the reference values in the sub-condition information indicating the “on-peak period” group by 2 as threshold values. If the display target period is from 9:00 to 10:00, the output data generation unit 402 may determine values obtained by multiplying threshold values per hour, which are given by “(the reference values for the on-peak period+the reference values for the mid-peak period)×½”, by 2 as final threshold values.

In this manner, by determining different threshold values for the time periods during which a store is crowded and the time periods during which the store is not crowded, the display control device 400 may provide a more appropriate presentation of the customer's staying behavior in each area within a store. For example, if a threshold value is uniformly determined using a reference value for the mid-peak period regardless of the time group, there might occur a situation in which almost all the areas are displayed in red for the on-peak period and almost all the areas are displayed in blue for the off-peak period. To avoid such a situation, the display control device 400 selects one of the sub-condition information D911, the sub-condition information D912, and the sub-condition information D913 in accordance with the time group to which the display target period belongs, and classifies the numbers of stayers in the respective areas by using the selected sub-condition information D911, sub-condition information D912, or sub-condition information D913. Accordingly, the display control device 400 may provide a viewer with a more appropriate presentation of the customer's staying behavior in each area within a store.

In addition, when the display target period is specified so as to extend over different time groups, threshold values are determined by using the sub-condition information for both time groups. Thus, the display control device 400 may determine appropriate threshold values by taking both time groups into account. In the foregoing description, the display target period is specified so as to extend over two time groups, by way of example. The display target period may be specified so as to extend over three time groups. In this case, it may be sufficient that the output data generation unit 402 determines threshold values by using the sub-condition information corresponding to the three time groups. In this case, the output data generation unit 402 may determine threshold values by calculating, for example, values given by (the reference values for the on-peak period+the reference values for the mid-peak period+the reference values for the off-peak period)×⅓, or may calculate weighted average values of the reference values in accordance with the proportions of the three time groups in the display target period to obtain threshold values.

In the example illustrated in FIG. 9A, a display color is used as the display style. Similarly to FIG. 8, any other display style such as a pattern may be used.

The display control device 400 according to this embodiment may determine threshold values in accordance with conditions other than the conditions illustrated in FIG. 8 and FIG. 9A.

For example, time groups respectively indicating the time periods of morning, afternoon, evening, and late night may be set, and condition information including sub-condition information for each time group may be used. Alternatively, groups respectively indicating weekdays and holidays/weekends may be set, and condition information including sub-condition information for each group may be used. Alternatively, groups respectively indicating the days of week may be set, and condition information including sub-condition information for each group may be used. Alternatively, groups respectively indicating seasons and months may be set, and condition information including sub-condition information for each group may be used. In the above-described examples, the display control device 400 according to this embodiment decides the associated group in accordance with the display target period, and determines threshold values.

Alternatively, groups may be set in accordance with the location condition of the display target store, and condition information including sub-condition information for each group may be used. Examples of the location condition include location in a business area, location in a residential area, spatial proximity to high schools, spatial proximity to technical schools, colleges, or universities, spatial proximity to highways, spatial proximity to railway stations, spatial proximity to bus stops or terminals, and spatial proximity to competitors. In the above-described examples, the display control device 400 according to this embodiment decides the associated group from the location condition of the display target store, and determines threshold values.

FIG. 9B is a diagram illustrating a data configuration of condition information D920 that is another example of condition information. The condition information D920 includes a plurality of (here, three) pieces of sub-condition information each corresponding to one of a plurality of location conditions, namely, sub-condition information D921, sub-condition information D922, and sub-condition information D923. In the sub-condition information D921, the sub-condition information D922, and the sub-condition information D923, a display color and a reference value are associated with each other.

Specifically, the condition information D920 includes a “group name” and a “location condition”. There are three groups indicating “location in a business area”, “spatial proximity to schools”, and “location in a residential area”. Thus, “business area location”, “spatial proximity to schools”, and “residential area location” are stored as “group names”. The “location condition” contains location conditions for determining which group of the “business area location”, “spatial proximity to schools”, and “residential area location” groups the location condition of the display target store belongs to.

For example, if the address of the display target store indicates that the display target store is located in a predetermined business area, it is determined that the display target store belongs to the “business area location” group. For example, if the address of the display target store indicates that a school is located within a radius of 100 m from the display target store, it is determined that the display target store belongs to the “spatial proximity to schools” group. For example, if the address of the display target store indicates that the display target store is located in a predetermined residential area, it is determined that the display target store belongs to the “residential area location” group.

The sub-condition information D921, the sub-condition information D922, and the sub-condition information D923 correspond to the “business area location”, “spatial proximity to schools”, and “residential area location” groups, respectively, and have the same data configuration as the condition information D800. In general, the number of customers who visit a store is considered to have a relationship of “business area location”>“spatial proximity to schools”>“residential area location”. Thus, in the example illustrated in FIG. 9B, reference values that are larger than those for the “spatial proximity to schools” group are used in the sub-condition information D921 for the “business area location” group, and reference values that are smaller than those for the “spatial proximity to schools” group are used in the sub-condition information D923 for the “residential area location” group.

The output data generation unit 402 determines which group among the groups defined in the condition information D920 the display target store belongs to, by using the address of the display target store, and determines threshold values by using one of the sub-condition information D921, the sub-condition information D922, and the sub-condition information D923 corresponding to the determined group. The output data generation unit 402 may determine final threshold values from the sub-condition information D921, the sub-condition information D922, and the sub-condition information D923 using the same technique as that illustrated in FIG. 9A described above.

The address of the display target store is stored in advance in, for example, the store information storage device 300. The display control device 400 may acquire the address of the display target store from the store information storage device 300 and map information from a map information server (not illustrated), and may determine which group the display target store belongs to by checking the acquired address against the map information.

In addition, groups may be set in accordance with the product items and services that the display target store handles, and condition information including sub-condition information for each group may be used. Examples of the product items and services that the display target store handles include the store size, the presence or absence of parking, the number of vehicles that can be parked, whether or not liquor is handled, whether or not drugs are handled, whether or not perishables are handled, the presence or absence of eat-in areas, and whether or not delivery services are handled. In the above-described examples, the display control device 400 according to this embodiment decides the associated group in accordance with the product items and services that the display target store handles, and determines threshold values.

FIG. 9C is a diagram illustrating a data configuration of condition information D930 that is another example of condition information. The condition information D930 includes a plurality of (here, three) pieces of sub-condition information each corresponding to one of a plurality of store sizes, namely, sub-condition information D931, sub-condition information D932, and sub-condition information D933. In the sub-condition information D931, the sub-condition information D932, and the sub-condition information D933, a display color and a reference value are associated with each other.

Specifically, the condition information D930 includes a “group name” and a “store size”. There are three groups indicating “large”, “medium-sized”, and “small”. Thus, “large”, “medium-sized”, and “small” are stored as “group names” in accordance with the store size. The “store size” contains conditions for determining which group of the “large”, “medium-sized”, and “small” groups the store size belongs to.

For example, if the display target store occupies an area that is greater than or equal to an area S1, it is determined that the display target store belongs to the “large” group. For example, if the display target store occupies an area that is greater than or equal to an area S2 and less than the area S1, it is determined that the display target store belongs to the “medium-sized” group. For example, if the display target store occupies an area that is less than the area S2, it is determined that the display target store belongs to the “small” group.

The sub-condition information D931, the sub-condition information D932, and the sub-condition information D933 correspond to the “large”, “medium-sized”, and “small” groups, respectively, and have the same data configuration as the condition information D800. In general, it is considered that the larger the number of customers who visit a store, the larger the area the store occupies. Thus, in the example illustrated in FIG. 9C, reference values that are larger than those for the “medium-sized” group are used in the sub-condition information D931 for the “large” group, and reference values that are smaller than those for the “medium-sized” group are used in the sub-condition information D933 for the “small” group.

The output data generation unit 402 determines which group among the groups defined in the condition information D930 the display target store belongs to, by using the area that the display target store occupies, and determines threshold values using one of the sub-condition information D931, the sub-condition information D932, and the sub-condition information D933 corresponding to the determined group. The output data generation unit 402 may determine final threshold values from the sub-condition information D931, the sub-condition information D932, and the sub-condition information D933 using the same technique as that illustrated in FIG. 9A described above. The area that the display target store occupies is stored in advance in, for example, the store information storage device 300, and the display control device 400 may acquire the area that the display target store occupies from the store information storage device 300.

The output data generation unit 402 may also determine threshold values in accordance with the previous studies on the number of visitors of the display target store and the number of persons staying in the display target store. In this case, for example, information in which the display style and reference values (the average number of visitors and proportions, such as A %, B %, and C %, of the total number of visitors) are associated with each other may be used as condition information. In this example, the output data generation unit 402 determines threshold values on the basis of the average number of visitors and the total number of visitors for the display target period (for example, in the last one week).

Specifically, values, such as A %, B %, and C % of the average number of visitors in the last one week, may be used as reference values. The condition information stores the reference values and the display style in association with each other. In this example, the output data generation unit 402 acquires stay information D500 on the stay in the display target store within the last one week from the store information storage device 300, and calculates the average numbers of visitors in the last one week from the acquired stay information D500. Then, the output data generation unit 402 calculates the ratio of the average number of visitors of each area in the last one week to the average number of visitors in the last one week. Then, the output data generation unit 402 classifies the calculated ratios by using the condition information, and determines display styles of the respective areas in accordance with the classification results.

Referring back to FIG. 3, the display 405 is composed of a display device such as a liquid crystal panel, and displays the map screen generated by the output data generation unit 402. Here, the display 405 is external to the display control device 400, for illustrative purposes only. The display 405 may be integrally formed with the display control device 400.

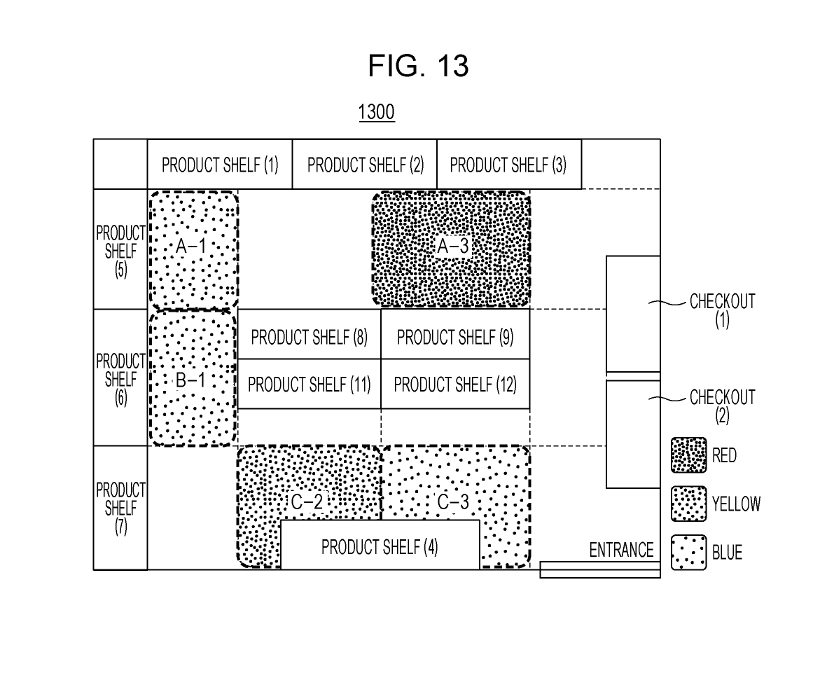

FIG. 13 is a diagram illustrating an example of a map screen 1300. On the map screen 1300, the customer's staying behavior is displayed in the layout diagram of the store 100 by area. On the map screen 1300, furthermore, the store 100 is partitioned into the areas illustrated in FIG. 12, and the numbers of stayers in the respective areas are displayed so as to be classified by using the condition information D800 in FIG. 8. Accordingly, an area in which the number of stayers is greater than or equal to 10 is displayed in red, an area in which the number of stayers is greater than or equal to 5 and less than or equal to 9 is displayed in yellow, an area in which the number of stayers is greater than or equal to 3 and less than or equal to 4 is displayed in blue, and an area in which the number of stayers is less than or equal to 2 is displayed colorlessly. In the example illustrated in FIG. 13, the areas A-1, B-1, and C-3 are displayed in blue, the area C-2 in yellow, and the area A-3 in red. The map screen 1300 thus depicts that the number of customers who stayed in the area A-3 is the largest.

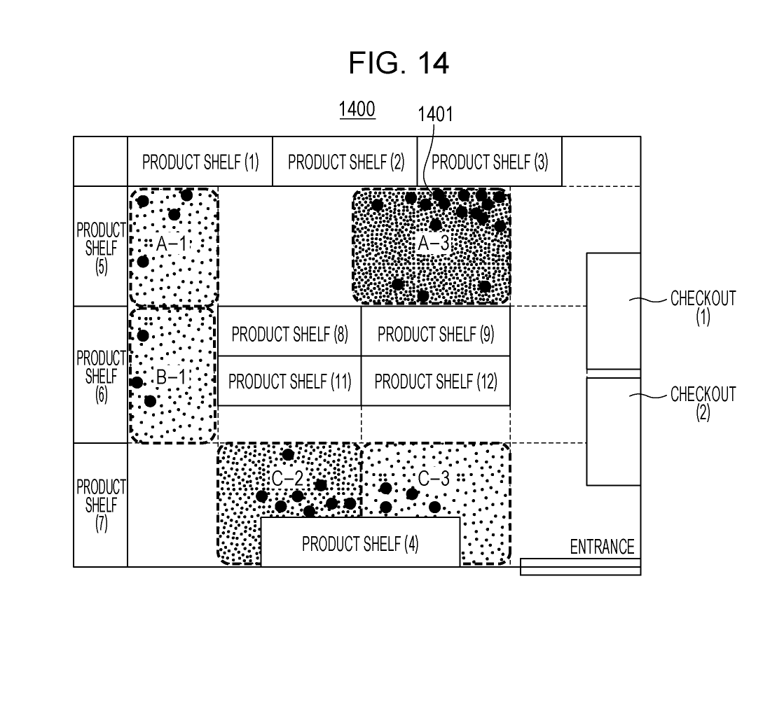

FIG. 14 is a diagram illustrating a map screen 1400 that is another example of a map screen. In the example illustrated in FIG. 14, similarly to FIG. 13, the customer's staying behavior in the store 100, which is partitioned into the areas in the manner illustrated in FIG. 12, is displayed in the layout diagram of the store 100. On the map screen 1400, furthermore, the areas are displayed so as to be classified by using the condition information D800 in FIG. 8. In the example illustrated in FIG. 14, similarly to FIG. 13, the areas A-1, B-1, and C-3 are displayed in blue, the area C-2 in yellow, and the area A-3 in red. The map screen 1400 thus depicts that the number of customers who stayed in the area A-3 is the largest.

The difference between the map screen 1400 and the map screen 1300 is that on the map screen 1400, staying locations of customers are displayed in the layout diagram. On the map screen 1400, a large number of dots 1401 each representing a staying location of a customer in the area A-3 are plotted, which indicates that customers gather in front of the product shelf (3). As depicted on the map screen 1400, the display of staying locations of customers in a layout diagram may allow the viewer to understand customer interest in a particular product shelf or product item in more detail.

To that end, it may be sufficient that the collection processing unit 202 generates stay information D500 in which, in addition to the number of persons staying in each area, a customer ID and a staying location are associated with each other for each area, and the information saving unit 203 saves the generated stay information D500 in the store information storage device 300 in association with the store ID. Then, it may be sufficient that the output data generation unit 402 plots dots 1401 at positions in the layout diagram which are indicated by the staying locations included in the stay information D500, and generate a map screen 1400.

In the manner described above, the stay information display system collects the stay information D500 on a display target store for a display target period, and displays customer's staying behavior in each area within the display target store in a layout diagram of the display target store. This may allow the viewer to view a map screen on which the customer's staying behavior in each area is presented in an easy-to-understand way. In addition, the stay information display system determines threshold values in accordance with the display target store, the display target period, and so forth, and classifies the numbers of stayers in the respective areas by using the determined threshold values. Thus, the stay information display system may appropriately classify the numbers of stayers in the respective areas in accordance with the display target store, the display target period, and so forth.

### 1.6 Operation of Stay Information Display System

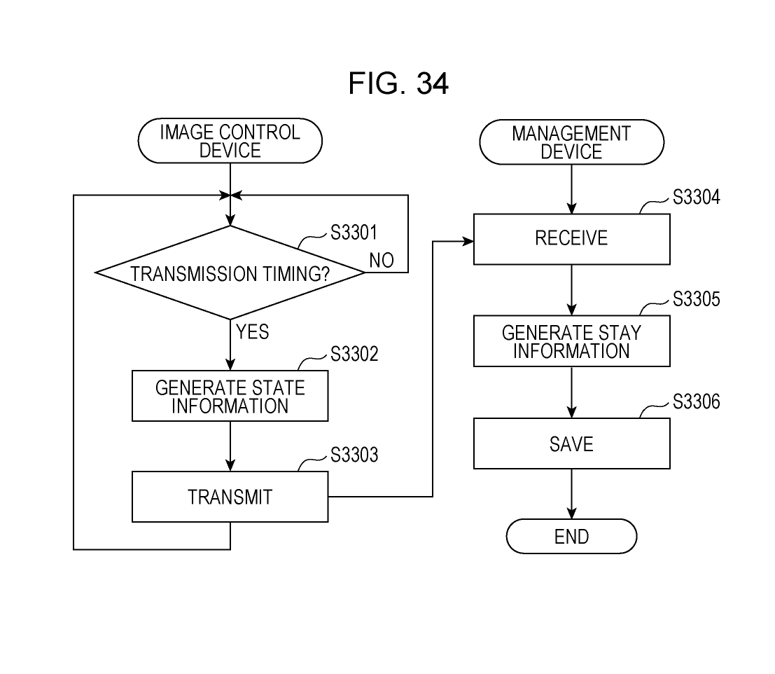

The operation performed in the stay information display system is divided into a collection phase to collect the stay information D500, and a display phase to display a map screen by using the collected stay information D500. FIG. 34 is a sequence diagram illustrating the operation in the collection phase. First, the image control device 101 determines whether or not the timing of the transmission of state information has arrived (S3301). In a case where the state information is transmitted on a daily basis, the transmission timing may be, for example, a predetermined time of day, such as the close time of the store 100 or 0:00 of the following day. In a case where the state information is transmitted in real time, the transmission timing may be, for example, the time at which a predetermined period of time (for example, 1 minute, 5 minutes, or 10 minutes) has elapsed. Here, the state information is transmitted every day, for illustrative purposes only. The state information may be transmitted every half a day, every other day, every week, or every month.

When the transmission timing has arrived (YES in S3301), the image control device 101 generates state information by arranging customer IDs and staying locations of customers detected using video data or using various sensors in chronological order (S3302). If the transmission timing has not arrived (NO in S3301), the process returns to S3301.

Then, the image control device 101 transmits the generated state information to the management device 200 via the network NT (S3303).

The receiving unit 201 of the management device 200 receives the state information (S3304). Then, the collection processing unit 202 calculates the number of stayers in each area by checking the staying locations included in the received state information against the area setting information D420, and generates stay information D500 (S3305).

Then, the information saving unit 203 saves the stay information D500 in the store information storage device 300 in association with the store ID (S3306). Thus, the stay information D500 illustrated in FIG. 5 is collected and accumulated in the store information storage device 300.

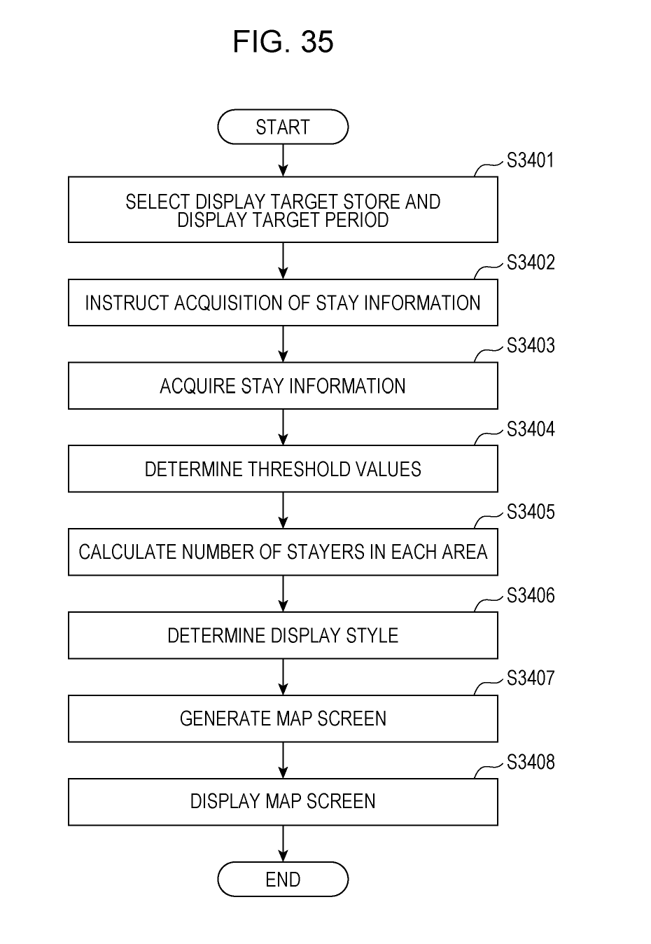

FIG. 35 is a flowchart illustrating the process in the display phase. Here, a description will be made using the use of the condition information D800 as an example. First, the selection unit 401 of the display control device 400 receives instructions to select a display target store and a display target period from the viewer (S3401).

Then, the output data generation unit 402 receives, from the selection unit 401, display target information including the display target period and the store ID of the display target store, and instructs the acquisition unit 403 to acquire the stay information D500 on the display target store for the display target period (S3402).

Then, the acquisition unit 403 acquires from the store information storage device 300 the stay information D500 on the display target store for the display target period, which is indicated in the instructions from the output data generation unit 402 (S3403).

Then, the output data generation unit 402 corrects the reference values defined in the condition information D800 into values in accordance with the display target period, and determines the obtained values as threshold values (S3404).

Then, the acquisition unit 403 calculates the numbers of stayers in the respective areas by using the stay information D500 acquired in S3402 (S3405).

Then, the output data generation unit 402 classifies the numbers of stayers in the respective areas using the threshold values determined in S3404, and determines the display styles of the respective areas in accordance with the classification results (S3406).

Then, the output data generation unit 402 generates a map screen on which the respective areas are displayed using the display styles determined in S3406 (S3407).

Then, the output data generation unit 402 displays the generated map screen on the display 405 (S3408).

Thus, the map screen 1300 illustrated in FIG. 13 is displayed on the display 405.

### (1) Display of Customer's Staying Behavior

In the following, a specific description will be given of screen transitions in the stay information display system. It is assumed here that the stay information display system has stored therein the stay information D500 collected from each store in the store information storage device 300. The collection procedure will not be described here.

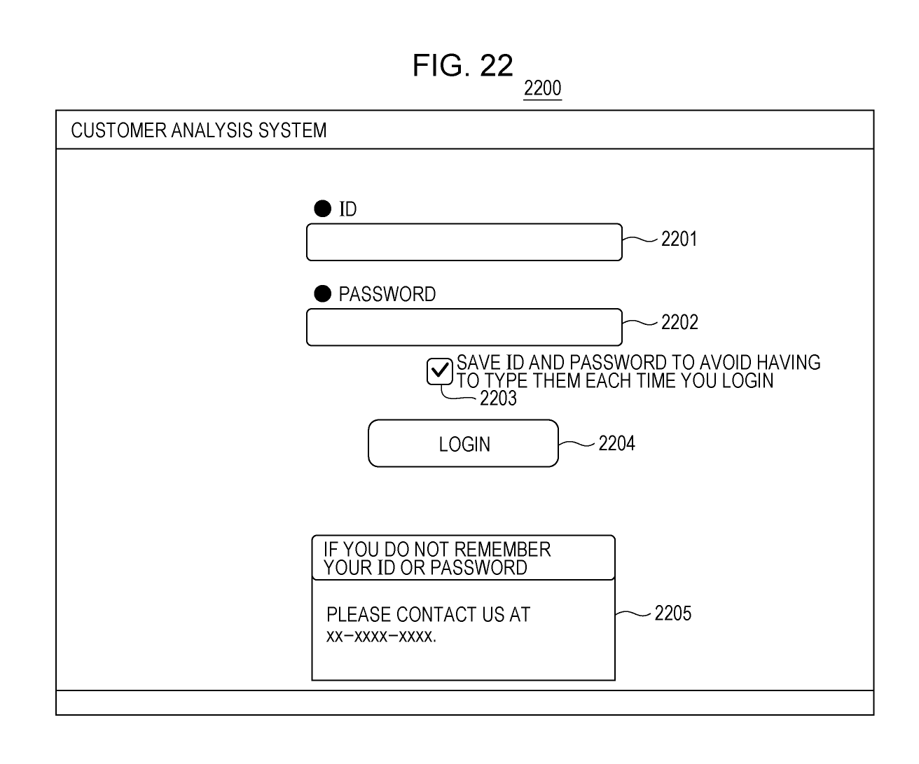

First, the display control device 400 displays a login screen 2200 illustrated in FIG. 22. For example, the display control device 400 displays the login screen 2200 upon receipt of instructions from the viewer to start the application on the display control device 400 in the stay information display system.

The login screen 2200 includes an ID input field 2201, a password input field 2202, a checkbox 2203, a login button 2204, and a message display field 2205.

The viewer enters their ID in the ID input field 2201 and their password in the password input field 2202, and selects the login button 2204. Then, the entered ID and password are transmitted to the management device 200.

When the login button 2204 is selected with the checkbox 2203 checked and the management device 200 determines that the entered ID and password are correct, the viewer will not be required to enter their ID and password for future use in order to log into the stay information display system.

A message display field 2205 provides display of a contact address for a viewer who might not remember their ID or password.

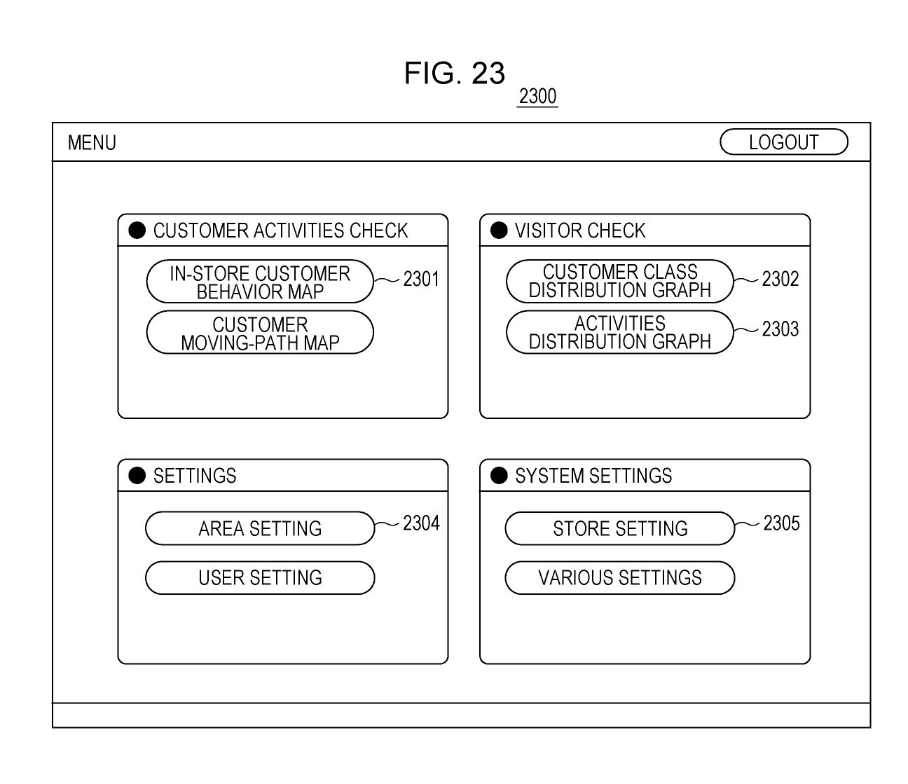

Then, the management device 200 receives the ID and password of the viewer from the display control device 400, and authenticates the ID and the password. If the management device 200 determines that the received ID and password are correct, the management device 200 prompts the viewer to log into the stay information display system, and causes a menu screen 2300 illustrated in FIG. 23 to be displayed on the display control device 400. If the management device 200 determines that the received ID and password are not correct, the management device 200 causes an error screen (not illustrated) indicating that the input information is not correct to be displayed on the display control device 400.

The menu screen 2300 provides display of a variety of functions that the stay information display system has in a list view. On the menu screen 2300, the variety of functions that the stay information display system has are categorized into four genres: “Customer activities check”, “Visitor check”, “Settings”, and “System settings”.

The “Customer activities check” category includes an “In-store customer behavior map” button 2301 for selecting a function of displaying the map screen 1300 illustrated in FIG. 13 or the like, and a “Customer moving-path map” button for selecting a function of displaying paths that customers follow in the store.

The “Visitor check” category includes a “Customer class distribution graph” button 2302 for selecting the display of a graph for the classes of visitors of the store, and an “Activities distribution graph” button 2303 for selecting the display of a graph for visitor activities. The “Settings” category includes an “Area setting” button 2304 for selecting a function of setting areas in the store, and a “User setting” button for selecting a function of registering a viewer. The “System settings” category includes a “Store setting” button 2305 for selecting a function of setting a store in the stay information display system, and so forth.

When the viewer or user selects the “In-store customer behavior map” button 2301 on the menu screen 2300, the stay information display system starts a process to display a map screen.

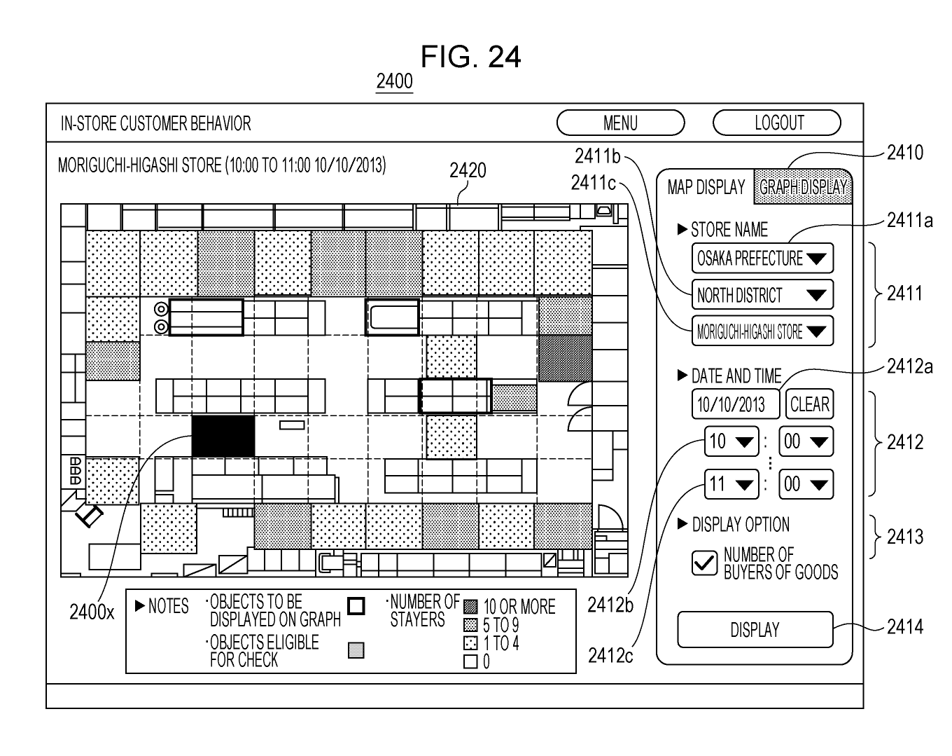

When the “In-store customer behavior map” button 2301 is selected by the viewer, the display control device 400 displays an in-store customer behavior map screen 2400 illustrated in FIG. 24. The in-store customer behavior map screen 2400 includes an input section 2410 in the right portion thereof, and a map display section 2420 in the left portion thereof.

The input section 2410 in FIG. 24 has a “Map display” tab and a “Graph display” tab. FIG. 24 depicts a state where the “Map display” tab has been selected by the viewer. The “Map display” tab has a store name input field 2411, a date and time input field 2412, an option input field 2413, and a display button 2414.

The viewer enters the name of a display target store in the store name input field 2411 and a display target period in the date and time input field 2412, and selects the display button 2414. Then, the selection unit 401 of the display control device 400 accepts the entered items as input.

The store name input field 2411 has three pull-down menus, that is, a pull-down menu 2411a for selecting a prefecture, a pull-down menu 2411b for selecting a district among the North, South, East, and West districts of the selected prefecture, and a pull-down menu 2411c for selecting a store located in the selected district. When a prefecture is selected in the pull-down menu 2411a and a district is selected in the pull-down menu 2411b, the names of stores located in the selected district of the selected prefecture are displayed as a list in the pull-down menu 2411c. The viewer selects one of the stores displayed as a list in the pull-down menu 2411c. Thus, the viewer is able to select a display target store.

In the example illustrated in FIG. 24, “the Moriguchi-Higashi store”, which is located in the “North district” of “Osaka prefecture”, is selected. Accordingly, a map screen of “the Moriguchi-Higashi store” is displayed in the map display section 2420.

The date and time input field 2412 has a date input field 2412a, a start-time input field 2412b, and an end-time input field 2412c. The date input field 2412a is used to designate a date in the display target period. In the example illustrated in FIG. 24, the date is input in the form of month/day/year. The start-time input field 2412b is used to designate the start time of the display target period. The end-time input field 2412c is used to designate the end time of the display target period. In the example illustrated in FIG. 24, the start time and the end time are input in the form of hour:minute.

The option input field 2413 shows the input of instructions to determine whether or not the number of buyers of goods is to be displayed in the map display section 2420. In a case where the number of buyers of goods is to be displayed in the map display section 2420, the viewer checks the checkbox in the option input field 2413.

When the operation of designating a display target store and a display target period is input by the viewer, the display control device 400 acquires the stay information D500 associated with the designated display target store and display target period from the store information storage device 300.

The display control device 400 determines threshold values corresponding to at least any one of the display target store and the display target period using the condition information D800, the condition information D910, or the like, and classifies the numbers of customers who stayed in the respective areas within the display target store by using the determined threshold values. Then, the display control device 400 displays the customer's staying behavior in the respective areas in the layout diagram of the display target store by using the display styles (such as colors or patterns) in accordance with the classification results. That is, the display control device 400 generates a map screen depicting the customer's staying behavior for each area, and displays the generated map screen in the map display section 2420 in the left portion of the in-store customer behavior map screen 2400.

The stay information display system has a function of displaying the details of the browning behavior of customers in a designated area when the area is designated by the viewer. An area for which the “designation flag” is set “ON” in the area setting information D420 illustrated in FIG. 4 is an area for which the customer's staying behavior is displayed in detail.

When the viewer selects the “Graph display” tab in the input section 2410 in FIG. 24, the display control device 400 displays the “Graph display” tab on the screen.

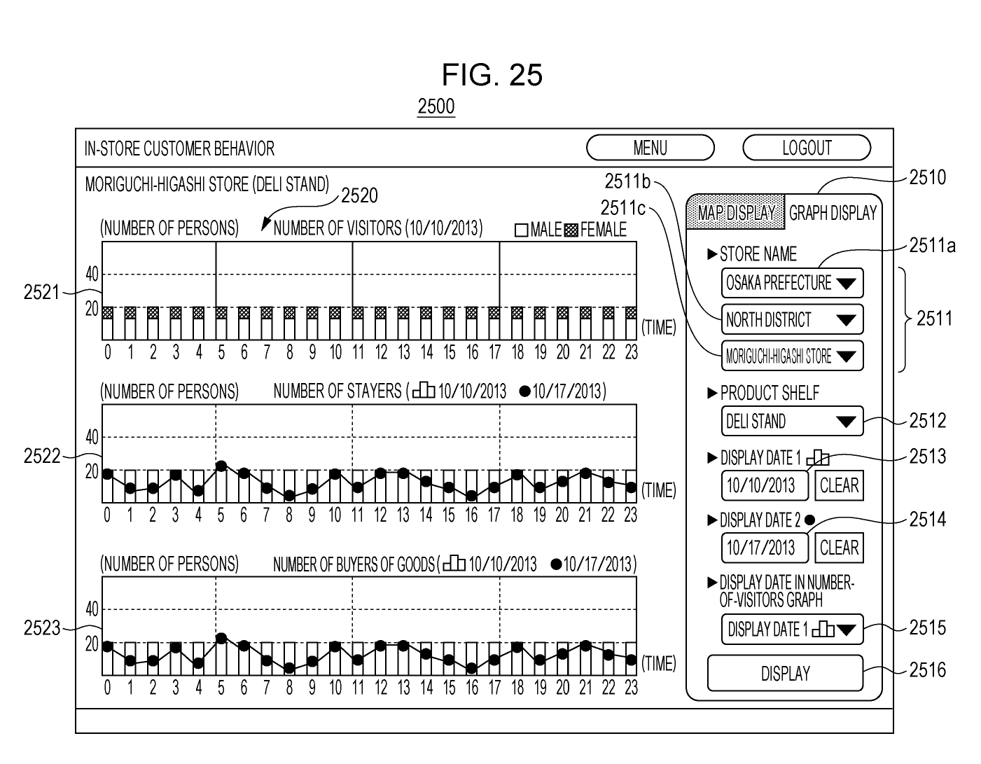

FIG. 25 is a diagram illustrating an example of an in-store customer behavior map screen 2500 when the “Graph display” tab is designated. The in-store customer behavior map screen 2500 includes an input section 2510 in the right portion thereof, and a graph display section 2520 in the left portion thereof.

The “Graph display” tab in the input section 2510 has a store name input field 2511, a product shelf input field 2512, a display date input field 2513, a display date input field 2514, a graph display date selection field 2515, and a display button 2516.

The viewer enters the name of a display target store in the store name input field 2511, the name of a product shelf to be targeted for the graph display of customer's staying behavior in the product shelf input field 2512, a first display date in the display date input field 2513, and a second display date in the display date input field 2514, and selects the display button 2516. Then, the display control device 400 accepts the entered items as input.

The display control device 400 selects an area for detailed display in accordance with the accepted input. Similarly to FIG. 24, the store name input field 2511 has three pull-down menus. The display control device 400 narrows down to stores by using a pull-down menu 2511a for selecting a prefecture and a pull-down menu 2511b for selecting a district, and displays only the resulting stores as a list in a pull-down menu 2511c for selecting a store.

In the product shelf input field 2512, only designated areas that may possibly be designated as areas for detailed display are displayed as a list in pull-down menu form. An area selected in the product shelf input field 2512 is displayed in the map display section 2420 illustrated in FIG. 24. In the illustrated example, a deli stand is selected. Accordingly, an area 2400x associated with the deli stand is displayed in a predetermined color in the map display section 2420.

A plurality of “display dates” on which the customer's staying behavior is to be displayed in graph form can be designated, and the customer's staying behavior on the display date entered in the display date input field 2513 labeled “display date 1” and the customer's staying behavior on the display date entered in the display date input field 2514 labeled “display date 2” are simultaneously displayed in graph form.

The display control device 400 acquires from the store information storage device 300 the stay information D500 associated with the selected designated area and information such as the number of visitors of the display target store and the number of buyers of goods. The display control device 400 displays, in graph form, the number of stayers in the selected designated area, the number of visitors of the store, and the number of buyers of goods on the selected display date. That is, the display control device 400 generates a graph screen depicting the details of the customer's staying behavior in each area, and displays the graph screen in the graph display section 2520 illustrated in the left part of FIG. 25.

In addition, by inputting the operation of selecting a designated area in the map display section 2420 in FIG. 24, the viewer is able to select the selected designated area as a designated area for detailed display. In this case, the display control device 400 may display designated areas which are selectable so as to surround the selectable designated areas with the thick lines 1201 illustrated in FIG. 12 in the map display section 2420, and allow the viewer to select a designated area by inputting the operation of selecting the designated area in the regions surrounded by the thick lines 1201 (for example, a click).

In the graph display section 2520 illustrated in FIG. 25, the Moriguchi-Higashi store is selected in the store name input field 2511, and a deli stand is selected in the product shelf input field 2512. Thus, three graph fields 2521 to 2523 depicting the number of visitors, the number of stayers, and the number of buyers of goods for the Moriguchi-Higashi store, respectively, are displayed. Here, the number of visitors represents the total number of visitors of the Moriguchi-Higashi store, the number of stayers represents the number of persons who stay at the deli stand, and the number of buyers of goods represents the number of customers who buy goods displayed at the deli stand.

The graph fields 2521 to 2523 depict graphs, each with the vertical axis representing the number of persons and the horizontal axis representing the times from 0:00 to 24:00. In the graph field 2521, the number of visitors at each point in time on the horizontal axis on Oct. 10, 2013, which is designated as the “display date 1”, is displayed in a bar graph by gender.

In the graph field 2522, the number of stayers at each point in time on the horizontal axis is displayed in a graph. In the graph field 2523, the number of buyers of goods at each point in time on the horizontal axis is displayed in a graph.

In the illustrated example, Oct. 10, 2013 is selected as the “display date 1”, and Oct. 17, 2013 is selected as the “display date 2”. Thus, the graphs for the two dates are simultaneously displayed in each of the graph fields 2522 and 2523.

In the illustrated example, the display of a bar graph for the “display date 1” is selected in the graph display date selection field 2515. Accordingly, in the graph field 2522, the numbers of stayers on the display date 1 are displayed in a bar graph, and the numbers of stayers on the display date 2 are displayed in a line graph. Also in the graph field 2523, similarly to the graph field 2522, the numbers of buyers of goods on the display date 1 are displayed in a bar graph, and the numbers of buyers of goods on the display date 2 are displayed in a line graph.

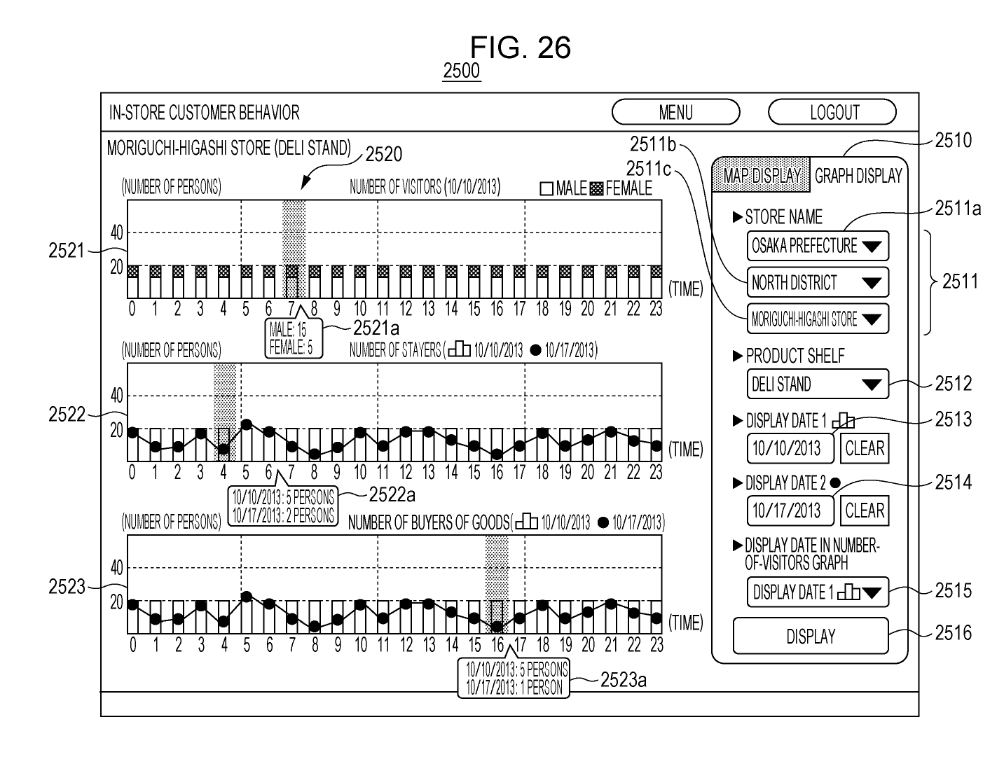

When the viewer points at a specific position in any of the graph fields 2521 to 2523 in FIG. 25, the display control device 400 displays the graph detail information corresponding to the specific position. FIG. 26 is a diagram illustrating an example of the in-store customer behavior map screen 2500 on which graph detail information is displayed.

In the illustrated example, a position corresponding to 7:00 is selected in the graph field 2521. Thus, graph detail information 2521a at 7:00 is displayed in association with 7:00 in the graph field 2521. Here, the number of visitors of the deli stand at 7:00 is 15 for male and 5 for female. In the graph detail information 2521a, accordingly, a message showing 15 male visitors and 5 female visitors is displayed in a balloon tip that pops up at the position corresponding 7:00.

In the graph field 2522, a position corresponding to 4:00 is selected. Thus, graph detail information 2522a at 4:00 is displayed in association with 4:00 in the graph field 2522. Here, the number of stayers at the deli stand at 4:00 is 5 on the display date 1 and 2 on the display date 2. In the graph detail information 2522a, accordingly, a message showing 5 persons on 10/10/2013 and 2 persons on 10/17/2013 is displayed in a balloon tip that pops up at the position corresponding 4:00.

Similarly, in the graph field 2523, graph detail information 2523a indicating a message showing 5 persons on 10/10/2013 and 1 person on 10/17/2013 is displayed in a balloon tip that pops up at the position corresponding 16:00.

In FIG. 25, the number of visitors may be calculated by using, for example, the stay information D500. In this case, each of the customer IDs included in the stay information D500 has an identifier that specifies male or female. The display control device 400 may calculate the total number of customer IDs of male customers and the total number of customer IDs of female customers on an hourly basis to separately calculate the number of male visitors and the number of female visitors. To that end, it may be sufficient that the image control device 101 distinguishes male and female visitors by using silhouettes of persons appearing on an image based on video data and creates state information including the results.

In FIG. 25, furthermore, the number of stayers can also be calculated by using the stay information D500. In this case, in the stay information D500, the customer ID of a customer detected from video data and an area in which the customer stayed are associated with each other. The display control device 400 may count the number of customer IDs for each area on an hourly basis to calculate the number of stayers in the selected area per hour.

In FIG. 25, furthermore, the number of buyers of goods is calculated based on collection data collected by, for example, a point of sale (POS) system installed in the store. In this case, the store information storage device 300 stores collection data collected by a POS system installed in each store. The collection data includes the history of sales of each product item for sale in each store. In the history of sales, for example, the time of sale of a product and the ID of the product are associated with each other. Accordingly, the display control device 400 may calculate the number of buyers of goods by acquiring the history of sales in the display target store on the display date 1 and display date 2 from the store information storage device 300 and calculating the number of purchasers of the goods for sale in the selected designated area (here, the deli stand) from the acquired history of sales on an hourly basis.

### (2) Display of Customer Class Distribution

When the viewer selects the “Customer class distribution graph” button 2302 on the menu screen 2300 in FIG. 23, the stay information display system starts a process to display a customer class distribution graph.

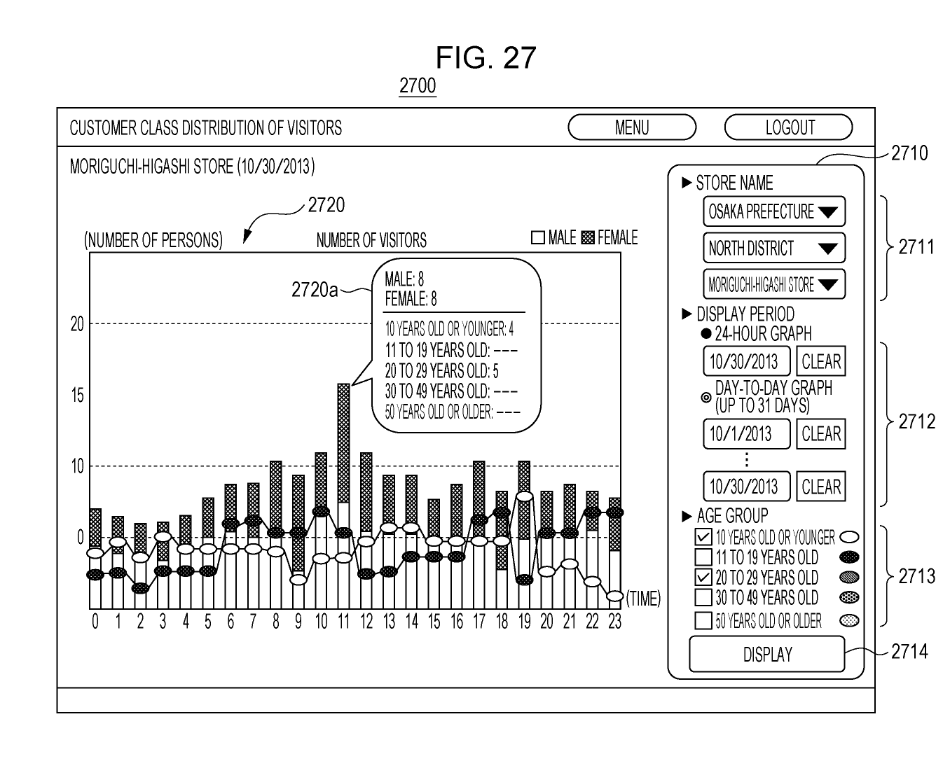

When the “Customer class distribution graph” button 2302 is selected, the display control device 400 displays a customer class distribution graph screen 2700 illustrated in FIG. 27. FIG. 27 is a diagram illustrating an example of the customer class distribution graph screen 2700. The customer class distribution graph screen 2700 includes an input section 2710 in the right portion thereof, and a graph display section 2720 in the left portion thereof.

The input section 2710 has a store name input field 2711, a display period input field 2712, an age group input field 2713, and a display button 2714.

The viewer enters the name of a display target store in the store name input field 2711 and a display target period in the display period input field 2712 within the input section 2710, and selects the display button 2714. Then, the display control device 400 accepts the entered items as input. The display control device 400 selects the display target store and the display target period in accordance with the accepted input.

Similarly to FIG. 24, the store name input field 2711 has three pull-down menus. The display control device 400 displays only stores that are selectable as a target for which the customer's staying behavior is to be displayed in the store name input field 2711 in pull-down menu form. In addition, when an age group is specified in the age group input field 2713, the display control device 400 displays the number of visitors in the specified age group in graph form.

The display control device 400 acquires from the store information storage device 300 information such as the number of visitors associated with the display target store and the display target period and the gender and age group of visitors. Then, the display control device 400 displays the number of visitors of the display target store in graph form by customer class. That is, the display control device 400 generates a graph of visitors of the display target store by customer class, and displays the graph in the graph display section 2720 illustrated in the left part of FIG. 27.

In the example illustrated in FIG. 27, a “24-hour graph” is specified in the display period input field 2712. Thus, the display control device 400 displays the number of visitors per hour on a designated date (here, Oct. 30, 2013) in the graph display section 2720.

The graph display section 2720 depicts a graph with the vertical axis representing the number of persons and the horizontal axis representing the times from 0:00 to 24:00. In the graph display section 2720, furthermore, the number of visitors is represented in a bar graph by gender, and the number of visitors is represented in a line graph by age group.

The Moriguchi-Higashi store is selected in the store name input field 2711, a 24-hour graph for Oct. 30, 2013 is selected in the display period input field 2712, and two age groups, that is, 10 years old or younger and 20 to 29 years old, are selected in the age group input field 2713. Thus, a bar graph depicting the number of visitors of the Moriguchi-Higashi store on Oct. 30, 2013 on an hourly basis by gender is displayed in the graph display section 2720. In addition, a line graph depicting the number of visitors in the age group of 10 years old or younger who visit the same store on the same date on an hourly basis, and a line graph depicting the number of visitors in the age group of 20 to 29 years old who visit the same store on the same date on an hourly basis are displayed in the graph display section 2720.

When the viewer points at a specific position in the graph display section 2720 in FIG. 27, the display control device 400 displays the graph detail information corresponding to the specific position. In the illustrated example, a position corresponding to 11:00 is selected in the graph display section 2720. Thus, graph detail information 2720a at 11:00 is displayed in association with 11:00 in the graph display section 2720. Here, the number of visitors of the Moriguchi-Higashi store at 11:00 is 8 for male and 8 for female. In addition, the number of visitors in the age group of 10 years old or younger is 4, and the number of visitors in the age group of 20 to 29 years old or younger is 5. In the graph detail information 2720a, accordingly, a message showing 8 male visitors, 8 female visitors, 4 persons aged 10 years old or younger, and 5 persons aged 20 to 29 years old or younger is displayed in a balloon tip that pops up at the position corresponding 11:00.

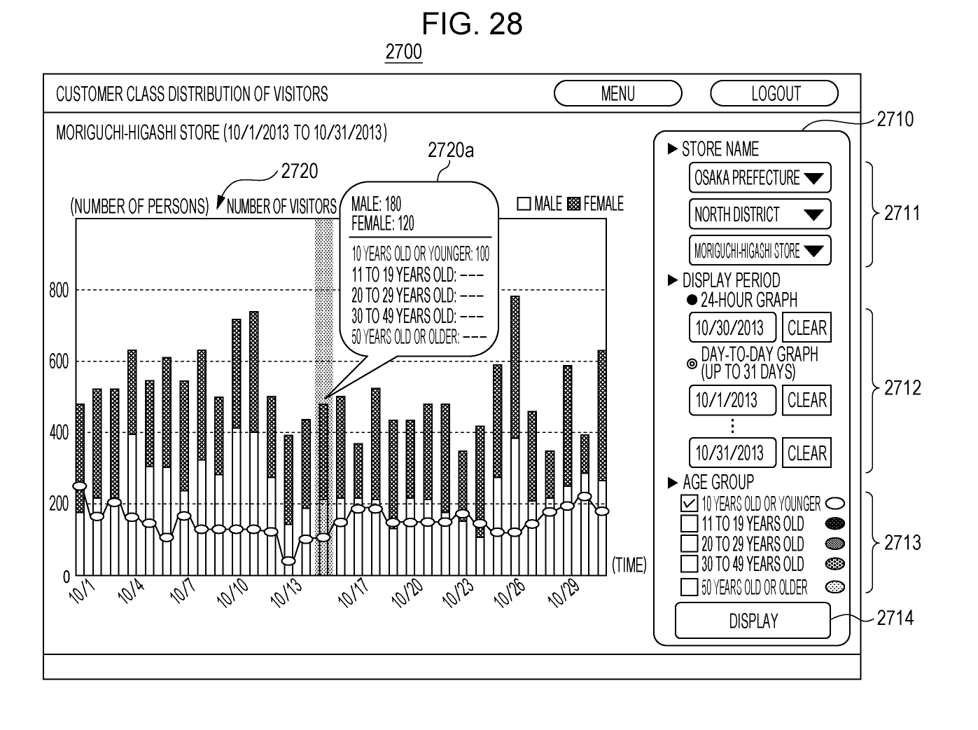

In addition, when a “day-to-day graph” is specified in the display period input field 2712 of the customer class distribution graph screen 2700, a customer class distribution graph screen 2700 illustrated in FIG. 28 is displayed. FIG. 28 is a diagram illustrating an example of the customer class distribution graph screen 2700 when a “day-to-day graph” is selected.

In FIG. 28, a “day-to-day graph” for the period of Oct. 1 to 31, 2013 is specified in the display period input field 2712. Thus, the display control device 400 displays the number of day-to-day visitors for the designated period (from Oct. 1, 2013 to Oct. 31, 2013) in graph form.

Specifically, since the age group of 10 years old or younger is selected in the age group input field 2713, a bar graph depicting the number of visitors of the Moriguchi-Higashi store for the designated period on a daily basis by gender, and a line graph depicting the number of visitors in the age group of 10 years old or younger who visited the Moriguchi-Higashi store for the designated period on a daily basis are displayed in the graph display section 2720.

When the viewer points at a specific position in the graph display section 2720 in FIG. 28, the display control device 400 displays the graph detail information corresponding to the specific position. In the illustrated example, Oct. 15, 2013 is selected in the graph display section 2720. Thus, graph detail information 2720a on Oct. 15, 2013 is displayed in association with 10/15/2013 in the graph display section 2720. Here, the number of visitors of the Moriguchi-Higashi store on Oct. 15, 2013 was 180 for male and 120 for female. In addition, the number of visitors in the age group of 10 years old or younger was 100. In the graph detail information 2720a, accordingly, a message showing 180 male visitors, 120 female visitors, and 100 persons aged 10 years old or younger is displayed in a balloon tip that pops up at the position corresponding 10/15/2013.

### (3) Display of Activities Distribution

When the viewer selects the “Activities distribution graph” button 2303 on the menu screen 2300 in FIG. 23, the stay information display system starts a process to display an activities distribution graph.

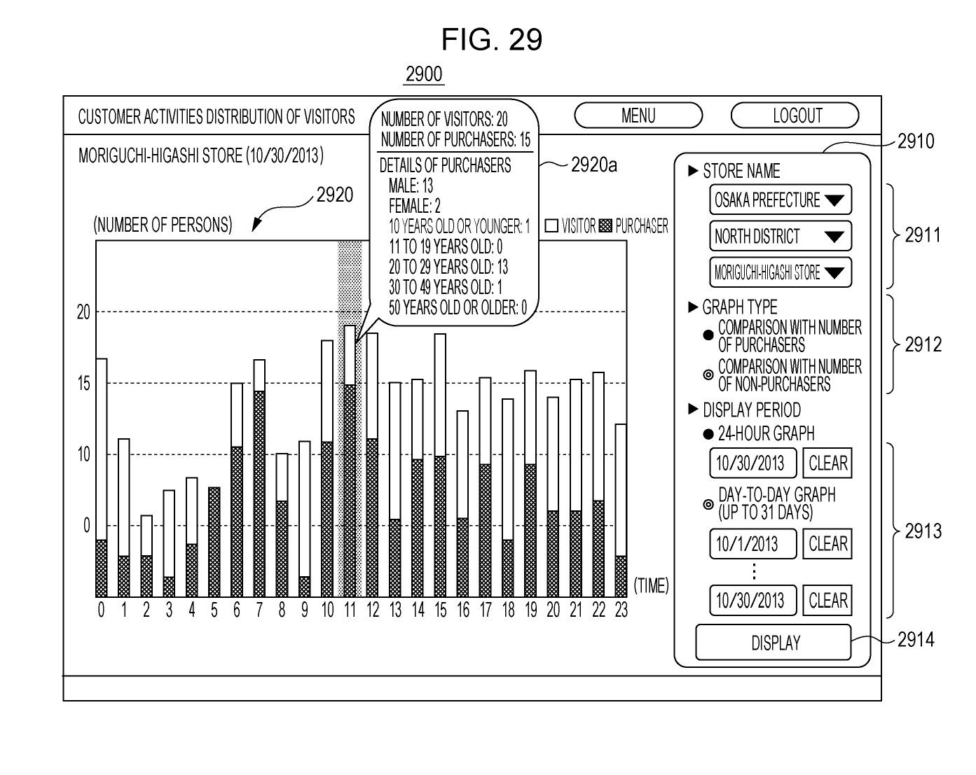

When the “Activities distribution graph” button 2303 is selected, the display control device 400 displays an activities distribution graph screen 2900 illustrated in FIG. 29. FIG. 29 is a diagram illustrating an example of the activities distribution graph screen 2900. The activities distribution graph screen 2900 includes an input section 2910 in the right portion thereof, and a graph display section 2920 in the left portion thereof.

The input section 2910 has a store name input field 2911, a graph type selection field 2912, a display period input field 2913, and a display button 2914.

The viewer enters the name of a display target store in the store name input field 2911 and a display target period in the display period input field 2913 within the input section 2910, and selects the display button 2914. Then, the display control device 400 accepts the entered items as input. The display control device 400 selects the display target store and the display target period in accordance with the accepted input. Similarly to FIG. 24, the store name input field 2911 has three pull-down menus. The display control device 400 displays only stores that are selectable as a target for which the customer's staying behavior is to be displayed in the store name input field 2911 in pull-down menu form.

In addition, the graph type selection field 2912, the viewer is allowed to select “comparison with the number of purchasers” or “comparison with the number of non-purchasers”. When “comparison with the number of purchasers” is selected, the display control device 400 displays an activities distribution graph in which the number of visitors is compared with the number of purchasers in the graph display section 2920. When “comparison with the number of non-purchasers” is selected, the display control device 400 displays an activities distribution graph in which the number of visitors is compared with the number of non-purchasers in the graph display section 2920.

The display control device 400 acquires from the store information storage device 300 information such as the number of visitors associated with the display target store and the display target period, the gender and age group of visitors, the number of purchasers, and the gender and age group of purchasers. The display control device 400 displays an activities distribution graph in which the number of visitors of the display target store is compared with the number of purchasers or an activities distribution graph in which the number of visitors of the display target store is compared with the number of non-purchasers. That is, the display control device 400 generates an activities distribution graph indicating the activities of visitors of the display target store, and displays the activities distribution graph in the graph display section 2920 illustrated in the left part of FIG. 29.

In the example illustrated in FIG. 29, a “24-hour graph” is specified in the display period input field 2913. Thus, the display control device 400 displays an activities distribution graph in which the number of visitors and the number of purchasers per hour on a designated date (here, Oct. 30, 2013) in the graph display section 2920.

The graph display section 2920 depicts a graph with the vertical axis representing the number of persons and the horizontal axis representing the times from 0:00 to 24:00. In the graph display section 2920, furthermore, an activities distribution graph in which a white bar graph depicting the number of visitors per hour and a shaded bar graph depicting the number of purchasers per hour are displayed superimposed on one another is displayed.

When the viewer points at a specific position in the graph display section 2920 in FIG. 29, the display control device 400 displays the graph detail information corresponding to the specific position. In the illustrated example, a position corresponding to 11:00 is selected in the graph display section 2920. Thus, graph detail information 2920a at 11:00 is displayed in association with 11:00 in the graph display section 2920. Here, the number of visitors of the Moriguchi-Higashi store was 20 and the number of purchasers in the Moriguchi-Higashi store was 15 at 11:00. In the graph detail information 2920a, accordingly, a message showing 20 visitors and 15 purchasers is displayed using a balloon tip that pops up at the position corresponding 11:00. In the graph detail information 2920a, furthermore, the details of purchasers by gender and age group are also displayed.

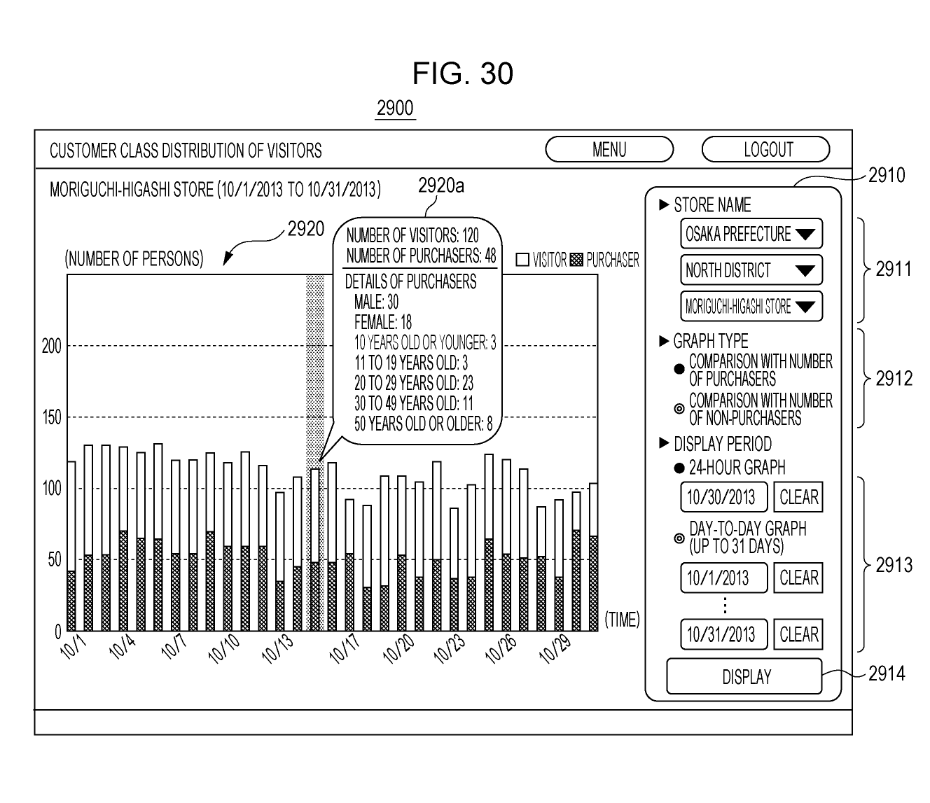

In addition, when a “day-to-day graph” is specified in the display period input field 2913 of the activities distribution graph screen 2900, an activities distribution graph screen 2900 illustrated in FIG. 30 is displayed. FIG. 30 is a diagram illustrating the activities distribution graph screen 2900 when a “day-to-day graph” is designated.

In FIG. 30, a “day-to-day graph” for the period of Oct. 1 to 31, 2013 is specified in the display period input field 2712. Thus, the display control device 400 displays a day-to-day activities distribution graph for the designated period (from Oct. 1, 2013 to Oct. 31, 2013).

Specifically, an activities distribution graph in which a white bar graph depicting the number of visitors of the Moriguchi-Higashi store for the designated period on a daily basis, and a shaded bar graph depicting the number of purchasers in the Moriguchi-Higashi store for the designated period on a daily basis are displayed superimposed on one another is displayed in the graph display section 2920.

When the viewer points at a specific position in the graph display section 2920 in FIG. 30, the display control device 400 displays the graph detail information corresponding to the specific position. In the illustrated example, a position corresponding to Oct. 15, 2013 is selected in the graph display section 2920. Thus, graph detail information 2920a on Oct. 15, 2013 is displayed in association with Oct. 15, 2013 in the graph display section 2920. Here, the number of visitors of the Moriguchi-Higashi store was 120 and the number of purchasers in the Moriguchi-Higashi store was 48 on Oct. 15, 2013. In the graph detail information 2920a, accordingly, a message showing 120 visitors and 48 purchasers is displayed using a balloon tip that pops up at the position corresponding 10/15/2013. In the graph detail information 2920a, furthermore, the details of purchasers by gender and age group are also displayed.

### (4) Area Setting

A person who performs setting (hereinafter referred to as the “setter”) selects the “Area setting” button 2304 on the menu screen 2300 in FIG. 23, allowing the stay information display system to start a process for area setting.

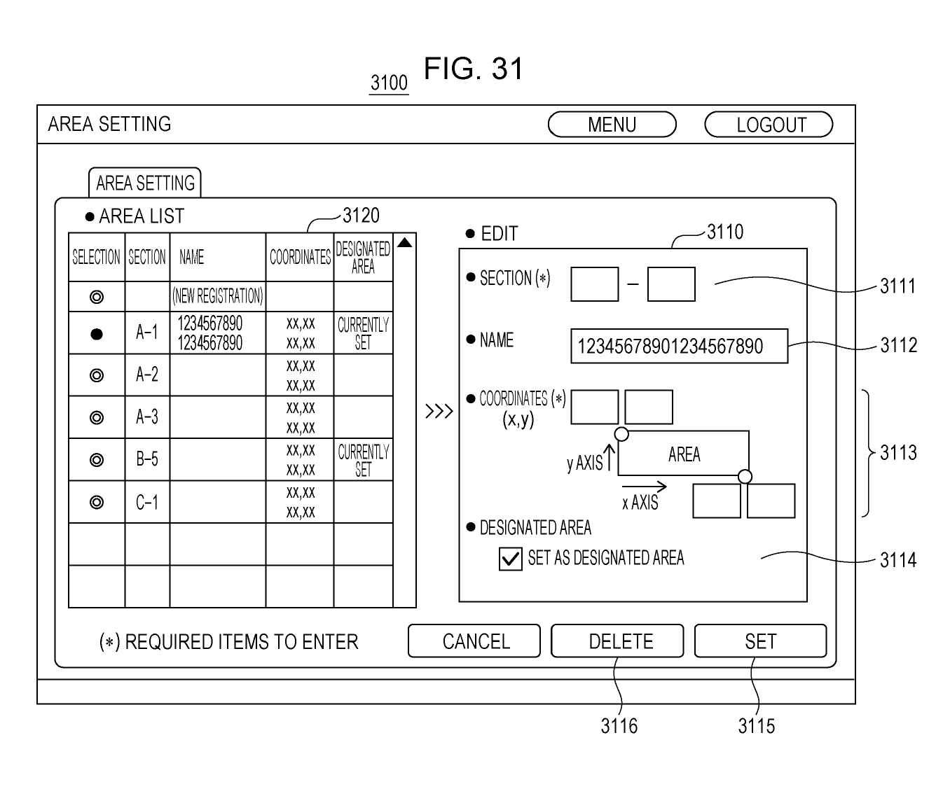

When the “Area setting” button 2303 is selected, the display control device 400 displays an area setting screen 3100 illustrated in FIG. 31. FIG. 31 is a diagram illustrating an example of the area setting screen 3100. The area setting screen 3100 in FIG. 31 includes an editing section 3110 in the right portion thereof, and an area list section 3120 in the left portion thereof.

The editing section 3110 has a section input field 3111, a name input field 3112, a coordinate input field 3113, and a designated area input field 3114.

As described with reference to FIG. 11, each section is defined by a combination of alphabetic and numeric characters. The alphabetic characters are used for sections of a department within a store in the vertical columns for distinguishing purposes. The numeric characters are used for sections of the department within the store in the horizontal rows for distinguishing purposes. Thus, the section input field 3111 has a field for entering an alphabetic character, and a field for entering a numeric character.

In the name input field 3112, a name for identifying an area is entered. The location of the area is defined by the (x, y) coordinates of the upper left vertex and lower right vertex of the area, which has a rectangular shape. Thus, the coordinate input field 3113 has a field for entering the coordinates of the upper left vertex of the area, and a field for entering the lower right vertex of the area.

The designated area input field 3114 is used to input whether or not the area currently being set in the editing section 3110 is a designated area selectable as a target for which the customer's staying behavior is to be displayed.

The information entered by the setter in the editing section 3110 is reflected in the area list section 3120. In the example illustrated in FIG. 31, the editing section 3110 depicts information concerning the area whose “section” in the area list section 3120 is “A-1”. Thus, the information entered in the editing section 3110 is displayed in the row indicating “A-1” in the section of the area list section 3120.

The input to the respective fields in the editing section 3110 is completed and the setter selects a Set button 3115 in the area setting screen 3100. Then, the input information is reflected in the area setting information D420. The setter performs the operation described above on each area to set an area. The setter selects an area in the area list section 3120 and selects a Delete button 3116 while information concerning the selected area is displayed in the editing section 3110. Then, the selected area is deleted from the area setting information D420.

### (5) Store Setting

A setter selects the “Store setting” button 2305 on the menu screen 2300 in FIG. 23, allowing the stay information display system to start a process for store setting.

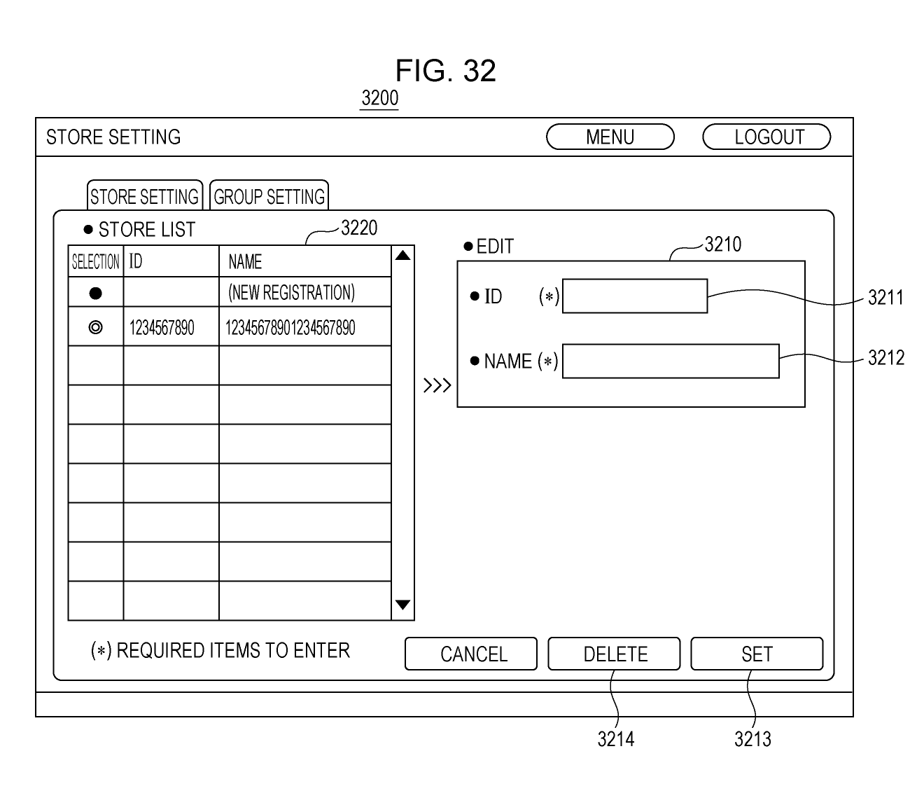

When the “Store setting” button 2305 is selected, the display control device 400 displays a store setting screen 3200 illustrated in FIG. 32. FIG. 32 is a diagram illustrating an example of the store setting screen 3200. The store setting screen 3200 includes an editing section 3210 in the right portion thereof, and a store list section 3220 in the left portion thereof.

The editing section 3210 has an ID input field 3211 and a name input field 3212. The setter enters the store ID of a store for which setting is to be performed in the ID input field 3211 and the name of the store in the name input field 3212 within the editing section 3210, and selects a Set button 3213. Then, information concerning the store for which setting is to be performed is added to the store list information D410.

In addition, the setter specifies one of the stores displayed as a list in the store list section 3220, and selects a Delete button 3214. Then, information concerning the specified store is deleted from the store list information D410.

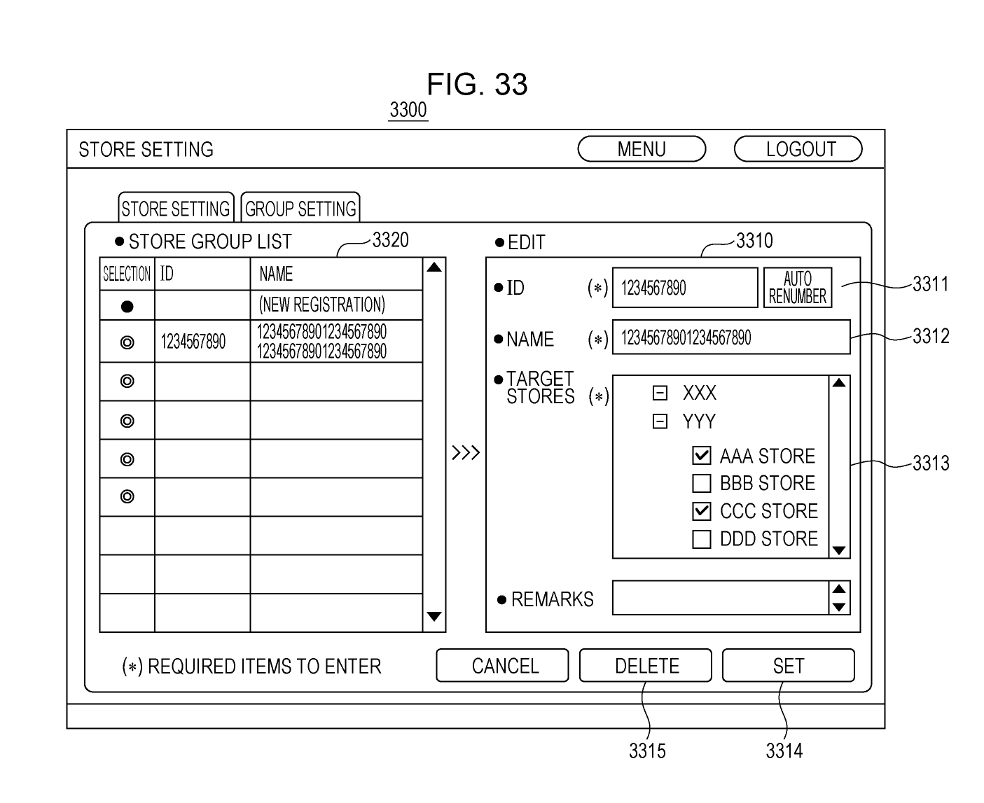

When a “Group setting” tab is selected on the store setting screen 3200, a group setting screen 3300 for setting a store group to which the store belongs is displayed. FIG. 33 is a diagram illustrating an example of the group setting screen 3300. The group setting screen 3300 includes a store group list section 3320 in the left portion thereof, and an editing section 3310 in the right portion thereof.

The editing section 3310 has an ID input field 3311, a name input field 3312, and a target store input field 3313.

The setter enters the ID of a store group for which setting is to be performed in the ID input field 3311 and the name of the store group in the name input field 3312, selects a store belonging to the store group in the target store input field 3313, and selects a Set button 3314. Then, information concerning the store group is saved in the store information storage device 300. Accordingly, the store group is created.

In addition, the setter selects one of the store groups displayed in the store group list section 3320, and selects a Delete button 3315. Then, the selected store group is deleted from the store information storage device 300. The stay information display system may enable simultaneous display of map screens of a plurality of stores by selecting a store group as a display target store.

### Modifications

(1) The acquisition unit 403 of the display control device 400 calculates the number of stayers in each area within a display target store for a display target period at predetermined time intervals. Then, the output data generation unit 402 of the display control device 400 may generate map screens at time intervals by classifying the numbers of stayers in each area calculated by the acquisition unit 403 at predetermined time intervals by using threshold values, and display the generated map screens in chronological order.

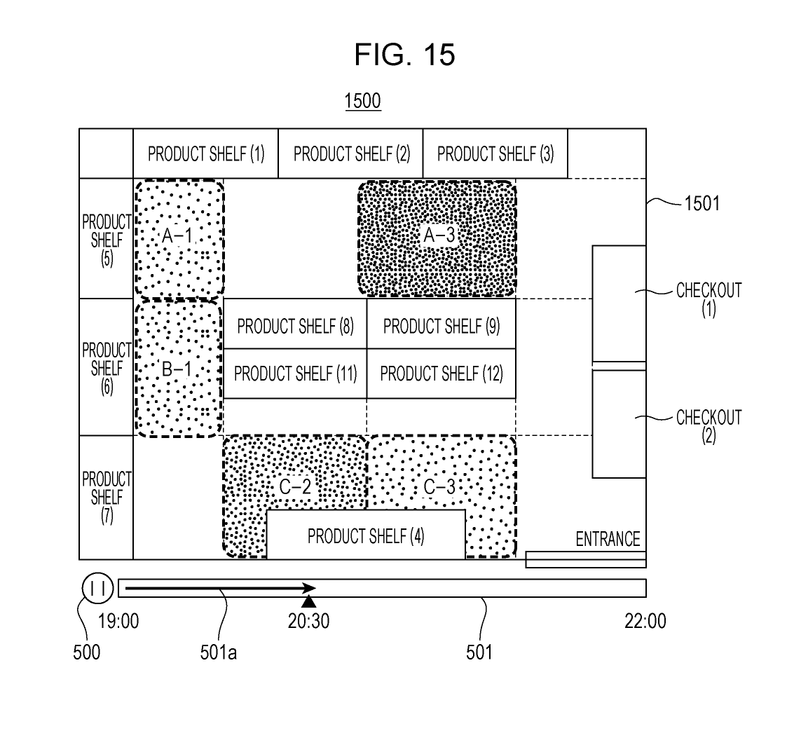

FIG. 15 is a diagram illustrating an example of a display screen 1500 when the period from 19:00 to 22:00 is selected as a display target period. The display screen 1500 has a map screen display section 1501 on which map screens are displayed in chronological order, a pause button 500, and a progress section 501. The progress section 501 indicates which date and time within the display target period from 19:00 to 22:00 the map screen currently being displayed in the map screen display section 1501 corresponds to. The progress section 501 has an arrow 501a whose length increases in accordance with the level in the progress bar displayed on a map screen in the map screen display section 1501.

When the progress bar on the map screen is started, the output data generation unit 402 switches the map screen to be displayed on the map screen display section 1501 in such a manner that the map screen for 19:00 is first displayed, the map screen for 19:05 is then displayed after 2 seconds, and the map screen for 19:10 is then displayed after further 2 seconds.

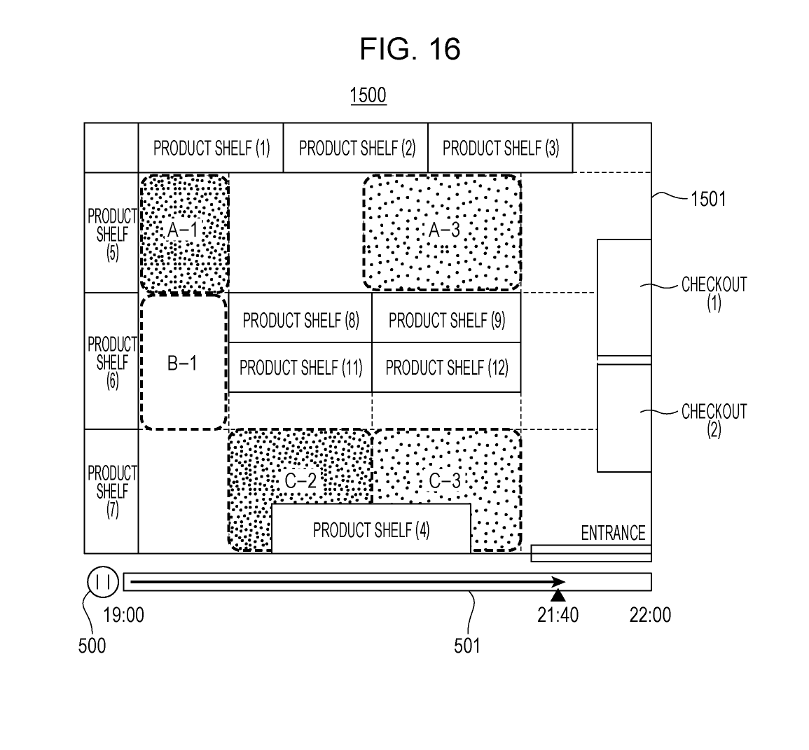

That is, the output data generation unit 402 displays map screens generated at predetermined time intervals (for example, at intervals of 5 minutes) at a predetermined frame rate (for example, 1 frame every 2 seconds) in chronological order, thereby providing the viewer with a presentation of changes in staying behavior over time during the display target period. In the example illustrated in FIG. 15, the map screen for 20:30 is currently displayed. FIG. 16 is a diagram illustrating an example of the display screen 1500 on which the map screen for 21:40 is currently displayed. When the pause button 500 is selected by the viewer, the output data generation unit 402 pauses the progress bar displayed on the map screen. This may allow the viewer to stop the display of map screens when the map screen for the desired time appears on the map screen display section 1501 to observe the map screen in detail.

To that end, it may be sufficient that the output data generation unit 402 creates the map screen 1300 illustrated in FIG. 13 at predetermined time intervals (for example, 5 minutes) by using the stay information D500 for the display target period, and displays the created map screens 1300 on the map screen display section 1501 at a predetermined frame rate (for example, 1 frame every 2 seconds) in chronological order.

In the foregoing, 5 minutes and 1 frame every 2 seconds are merely an example of the predetermined time interval and the predetermined frame rate, respectively, and other values may be used.

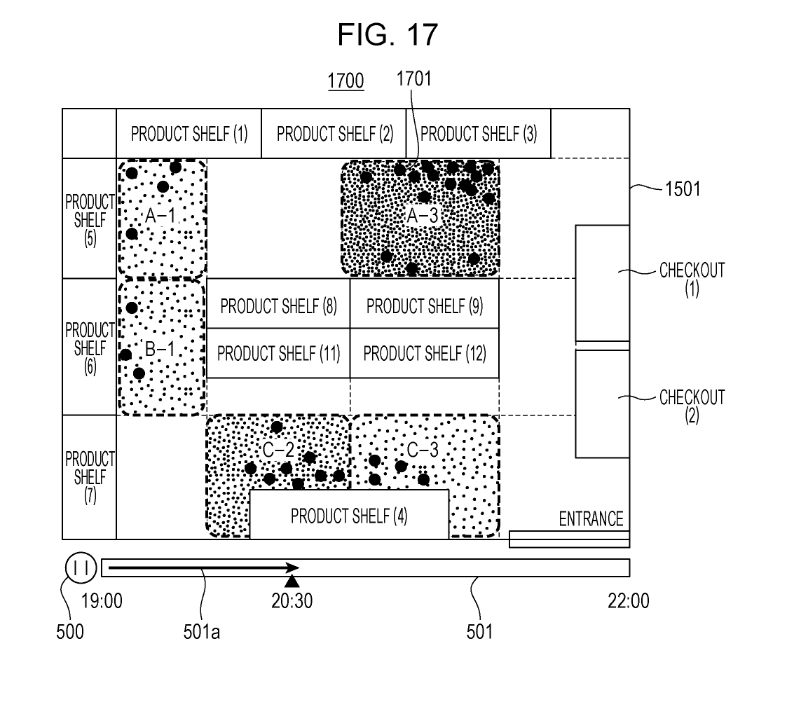

FIG. 17 is a diagram illustrating a display screen 1700 that is another example of a display screen when the period from 19:00 to 22:00 is selected as a display target period.

The display screen 1700 is different from the display screen 1500 in that staying locations of customers are displayed on a map screen. The map screen for 20:30 is displayed in the map screen display section 1501, and a great number of dots 1701 indicating staying locations of customers in the area A-3 are plotted on the displayed map screen, which indicates that customers gather in front of the product shelf (3).

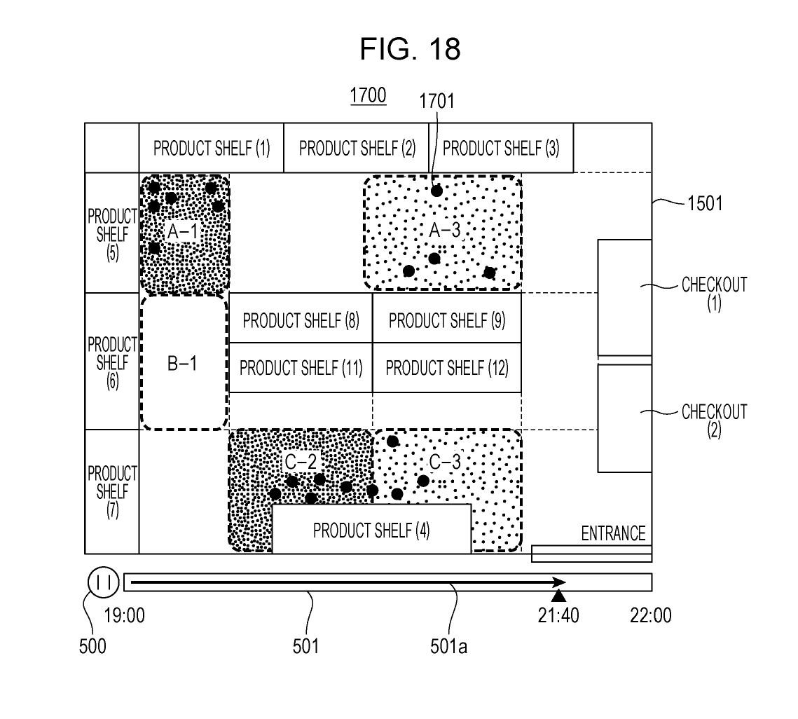

FIG. 18 is a diagram illustrating an example of a display screen 1700 on which the map screen for 21:40, which is obtained one hour and ten minutes later after the map screen illustrated in FIG. 17, is displayed. In FIG. 18, the number of dots 1701 plotted in the area A-3 is smaller than that in FIG. 17, which indicates that the gathering of customers in front of the product shelf (3) has been reduced. In FIG. 18, furthermore, the number of dots 1701 plotted near the product shelf (9) in the area A-3 is not much different from that in FIG. 17, which indicates that the number of customers staying in front of the product shelf (9) does not largely change. On the display screens 1700 illustrated in FIG. 17 and FIG. 18, the dots 1701 indicating staying locations of customers are displayed on the map screen, which may help the viewer understand customer interest in a particular product shelf or product item in more detail.

Accordingly, the stay information display system may provide a more appropriate presentation of changes in the customer's staying behavior in each store over time.

To that end, it may be sufficient that the output data generation unit 402 creates the map screen 1400 illustrated in FIG. 14 at predetermined time intervals (for example, 5 minutes) by using the stay information D500 for the display target period, and displays the created map screens 1400 in the map screen display section 1501 at a predetermined frame rate (for example, 1 frame every 2 seconds) in chronological order.

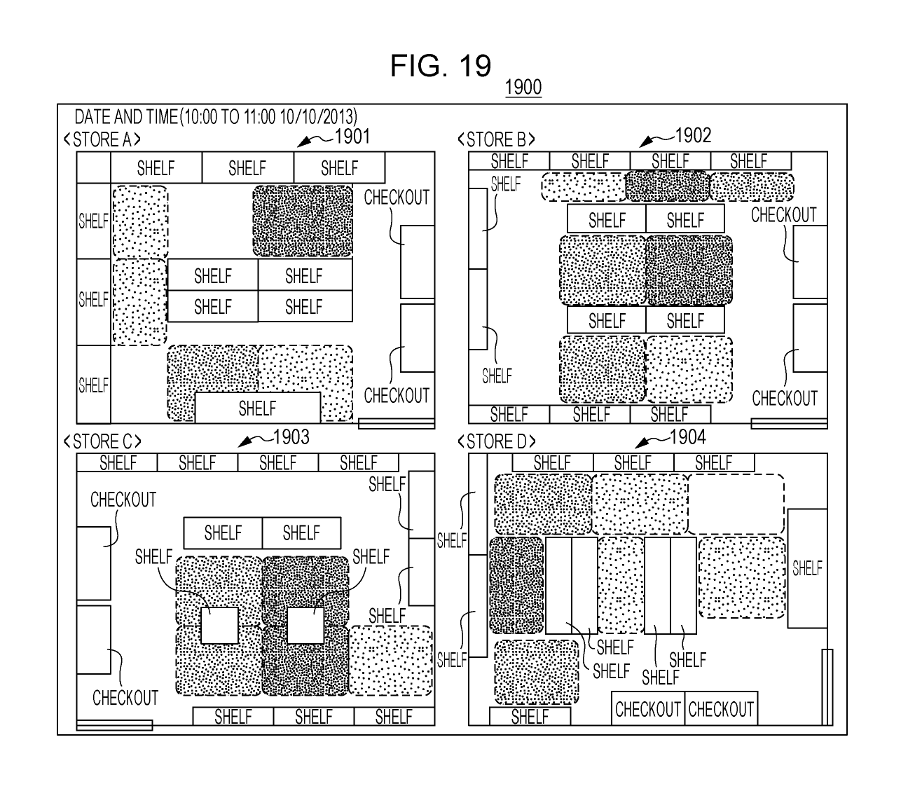

(2) The output data generation unit 402 may simultaneously display staying behaviors for a plurality of stores by using maps. FIG. 19 is a diagram illustrating an example of a display screen 1900 when four stores, that is, a store (A), a store (B), a store (C), and a store (D), are selected as display target stores. On the display screen 1900, map screens depicting the customer's staying behaviors within the selected four stores for each area are simultaneously displayed. In the illustrated example, the period from 10:00 to 11:00 on Oct. 10, 2013 is selected as a display target period. The display screen 1900 depicts a map screen 1901 of the store (A) in the upper left portion thereof, a map screen 1902 of the store (B) in the upper right thereof, a map screen 1903 of the store (C) in the lower left thereof, and a map screen 1904 of the store (D) in the lower right thereof.

The stay information display system determines threshold values, which are used for classification, in accordance with the feature of the display target store, the display target period, and so forth. To this end, it may be sufficient that, in a case where four stores to be simultaneously displayed have different features (such as location, product item for sale, service, and the number of visitors), the output data generation unit 402 determines different threshold values for the respective stores. It may further be sufficient that the output data generation unit 402 generates map screens of the respective stores by using the threshold values determined for the respective stores, and simultaneously displays the map screens on the display screen 1900. The threshold values may be determined using the technique described above. Specifically, the technique using the condition information D800, the technique using the condition information D910, D920, or D930, or the technique for determining values obtained by correcting threshold values per hour determined using the condition information D910, D920, or D930 in accordance with the display target period as threshold values is available.

In addition, the output data generation unit 402 may display the map screens 1901 to 1904, which are simultaneously displayed on the display screen 1900, by uniformly using the same threshold value.

For example, it is assumed that the viewer inputs the operation of specifying the store 100 on the display screen 1900 and the selection unit 401 accepts the operation. Then, the output data generation unit 402 generates the map screens 1902, 1903, and 1904 of the store (B), the store (C), and the store (D), respectively, by using the threshold values determined for the store (A), and displays the map screens 1902, 1903, and 1904 on the display screen 1900.

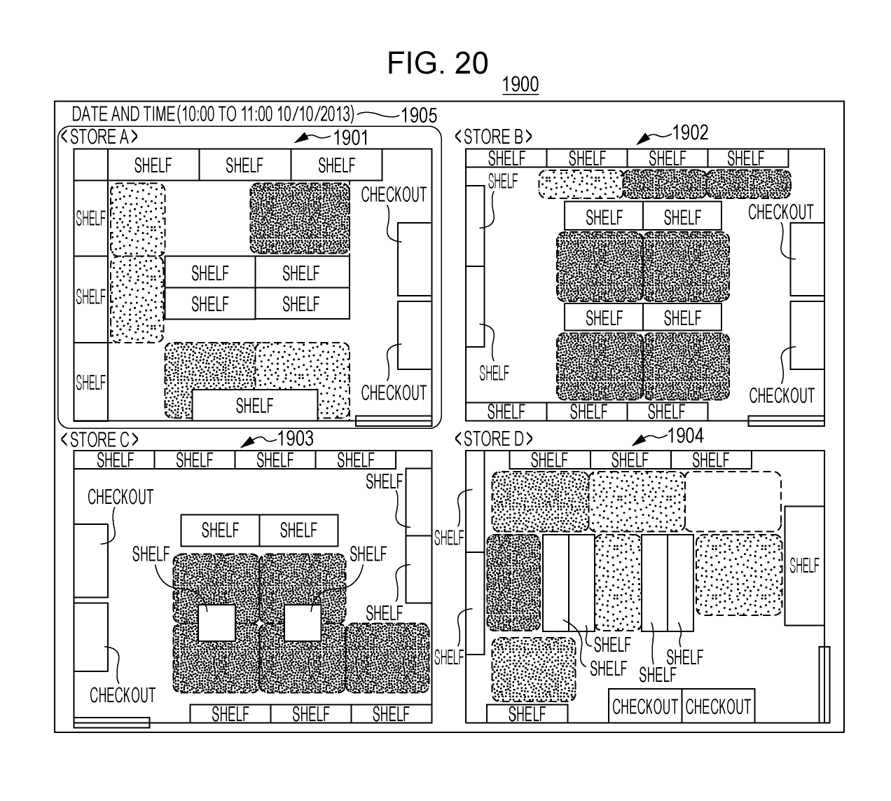

FIG. 20 is a diagram illustrating an example of the display screen 1900 when the store (A) is selected. Since the store (A) is selected on the display screen 1900 in FIG. 20, a cursor 1905 indicating the selection of the store (A) is displayed on the map screen 1901. The viewer may select the store (A) by, for example, inputting the operation of clicking on within a region of the map screen 1901.

Since the map screens 1902 to 1904 are generated by using the threshold values for the store (A), it may be seen that the display screen 1900 in FIG. 20 is different from the display screen 1900 in FIG. 19 in terms of the display style of the map screens 1902 to 1904.

The display screen 1900 illustrated in FIG. 20 may be suitable to determine the tendency of the four stores such that the number of stayers in the store (B) and the number of stayers in the store (C) are larger than the number of stayers in the store (A) and the number of stayers in the store (D). Meanwhile, the map screens 1902 and 1903 are generated using the threshold values for the store (A), and almost all the areas within the store (B) and the store (C) are displayed using a display style that indicates the highest staying behavior. Thus, the difference between the areas in terms of staying behavior is not clear.

To address this inconvenience, when the viewer selects the store (B) on the display screen 1900 illustrated in FIG. 20, the output data generation unit 402 generates the map screens 1901, 1903, and 1904 indicating the staying behaviors in the individual areas within the store (A), the store (C), and the store (D), respectively, by using the threshold values determined for the store (B), and displays the map screens 1901, 1903, and 1904 on the display screen 1900.

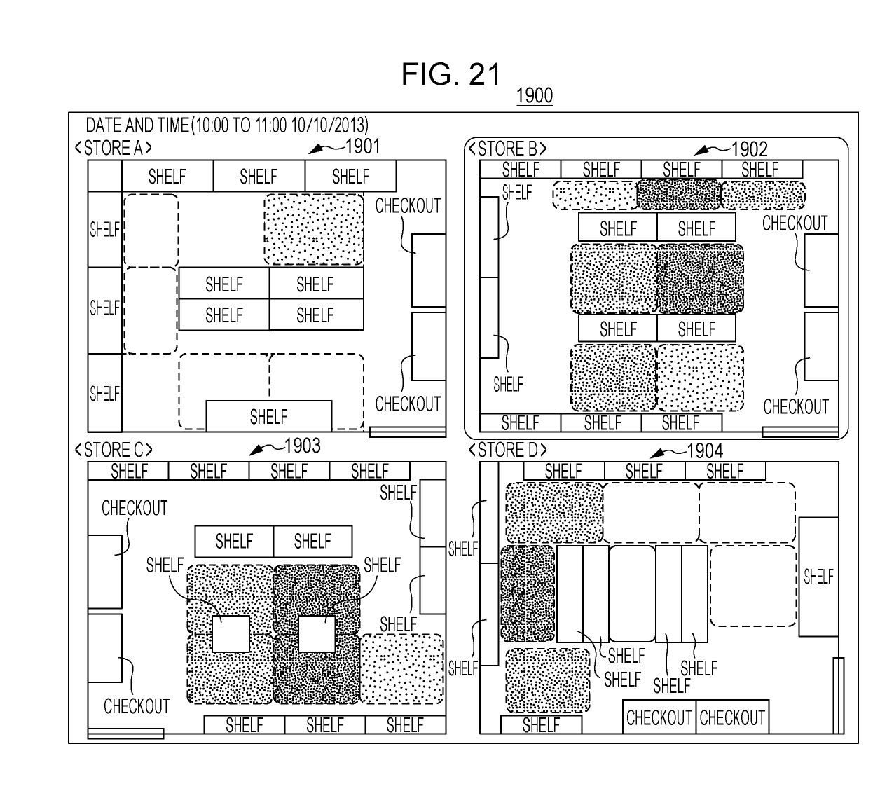

FIG. 21 is a diagram illustrating an example of the display screen 1900 when the store (B) is selected. It may be seen that, in FIG. 20, almost all the areas on the map screens 1902 and 1903 are displayed using a display style that indicates the highest staying behavior, whereas, in FIG. 21, the staying behaviors in the individual areas on the map screens 1902 and 1903 are displayed using different display styles. In FIG. 21, however, almost all the areas on the map screens 1901 and 1904 are displayed using a display style that indicates the lowest staying behavior. Accordingly, the display screen 1900 in FIG. 21 may be suitable to determine the difference between the staying behaviors in the store (B) and the store (C) for each area.

While four stores are selected on the display screen 1900 by way of example, the present disclosure is not limited to this example. A predetermined number of stores, such as two, three, or more than four stores, may be selected. In this case, a number of map screens corresponding to the number of selected stores are simultaneously displayed on the display screen 1900.

In the foregoing, by way of example, the store (A) or the store (B) is selected. The store (C) or the store (D) may be selected instead. In this case, the threshold values determined for the selected store (C) or store (D) are used to create map screens of the other stores.

(3) In a case where one store has a plurality of departments, the stay information display system may manage each department as a separate store, and set the plurality of departments as a store group. Further, the stay information display system may simultaneously display map screens indicating the staying behaviors in the individual areas within the plurality of departments.

(4) In a case where a gateway that manages the image control device 101 is located in a store, the image control device 101 may communicate with the management device 200 via the gateway. For example, in a case where a store has two departments on two floors, e.g., the first and second floors, and a different image control device 101 is installed in each of the first and second floors, it may be sufficient that the image control devices 101 on the respective floors transmit state information to the gateway and the gateway transfers the state information to the management device 200.

(5) In the embodiment described above, a single device has a plurality of functions (or constituent elements). However, the present disclosure is not limited to this configuration. When each function (or constituent element) is separated into a plurality of devices, and combinations of them achieve similar advantages or functions, such combinations also fall within the scope of the present disclosure.

(6) Some or all of the constituent elements forming each of the devices described above may be formed of an integrated circuit (IC) card or a single module that is removably attachable to the device. The IC card or the module is a computer system including a microprocessor, a read-only memory (ROM), a random access memory (RAM), and so forth. The IC card or the module may include super-multi-function large scale integration (LSI) chips as described above. The microprocessor operates in accordance with a computer program, allowing the IC card or the module to achieve the functions. The IC card or the module may have tampering resistance.

(7) An embodiment of the present disclosure may provide a computer program in accordance with which a computer implements the method described above, or a digital signal including the computer program.

In addition, an embodiment of the present disclosure may provide a computer-readable recording medium (such as a flexible disk, a hard disk, a compact disc ROM (CD-ROM), a magneto-optical (MO) disc, a digital versatile disc (DVD), a DVD-ROM, a DVD-RAM, a BD (Blu-ray Disc), or a semiconductor memory) having the computer program or the digital signal recorded thereon. An embodiment of the present disclosure may also provide the digital signal recorded on the above-described recording medium.

In an embodiment of the present disclosure, furthermore, the computer program or the digital signal may be transmitted via a telecommunications line, a wired or wireless communication line, a network such as the Internet, data broadcasting, or the like.

In addition, an embodiment of the present disclosure may provide a computer system including a microprocessor and a memory. The memory may store the computer program described above, and the microprocessor may operate in accordance with the computer program.

In an embodiment of the present disclosure, furthermore, the program or the digital signal may be implemented by another independent computer system by being recorded on the recording medium and transferred to the other independent computer system, or by being transferred to the other independent computer system via the network or the like.

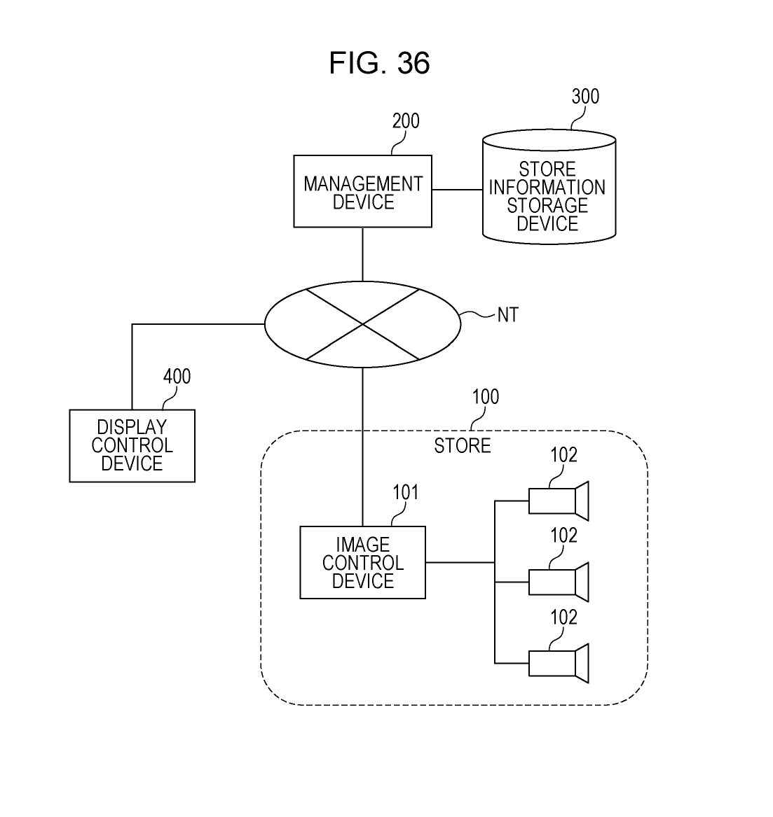

(8) The stay information display system may have a configuration illustrated in FIG. 36 instead of that illustrated in FIG. 1. FIG. 36 is a diagram illustrating another example configuration of the stay information display system according to this embodiment. In FIG. 1, the display control device 400 is connected to the management device 200 and the store information storage device 300 via a LAN, whereas, in FIG. 36, the display control device 400 is connected to the network NT. That is, in the configuration illustrated in FIG. 36, the management device 200 and the store information storage device 300 are configured as cloud devices, and the display control device 400 is connected to the cloud devices via the network NT. A manager who manages the cloud devices may be a company to which the store 100 belongs, a vendor that manufactured the stay information display system, or a service provider that manages services implemented by the stay information display system.

For example, the display control device 400 may be a computer installed in the store 100, or a mobile terminal that an employee of the store 100 carries. Examples of the mobile terminal may include a tablet terminal and a smartphone.

(9) In the present disclosure, the embodiment described above and the modifications described above may be used in combination.

Accordingly, the stay information display method and the stay information display system according to this embodiment may enable collection of stay information on stays of customers in each store and display of a map screen on which the customer's staying behavior in each area within the store is presented. In addition, the stay information display system may classify the staying behaviors in the individual areas within a store by using different display styles for display, and determine threshold values, which are to be used for classification, in accordance with the feature of the display target store, the display target period, and so forth, thereby providing a more appropriate presentation of the customer's staying behavior.

A stay information display system according to an embodiment of the present disclosure is suitable for use in a system that displays the customer's staying behavior in a store. In addition, a stay information display system according to an embodiment of the present disclosure is also applicable to uses such as systems for analyzing the activities of people in, for example, public facilities and hospitals.

What is claimed is:

1. A display method in a stay information display system, the stay information display system including a management device that collects stay information on stays of persons in a store, and a display control device that displays staying behavior of persons in the store on a display by using the collected stay information, the display method comprising:
receiving state information including a location at which a person stays in the store, the state information being generated based on video data obtained by capturing an image of inside of the store;
generating stay information in which a location at which a person stays in the store and date and time at which the person stays in the store are associated with each other, by using the received state information;
saving the generated stay information in a storage in association with store information indicating the store;
selecting a display target period and a display target store;
calculating the numbers of persons staying in a plurality of areas within the display target store for the display target period, by using the saved stay information;
determining threshold values in accordance with at least any one of the display target period and the display target store, by using condition information that specifies a condition for determining threshold values used to classify the numbers of persons staying in the plurality of areas within the store;
classifying the calculated numbers of persons staying in the plurality of areas by using the determined threshold values;
generating a map screen on which staying behaviors of persons in the plurality of areas are mapped onto a layout screen of the store by using display styles in accordance with a result of the classification, and
displaying the map screen on the display.

2. The display method according to claim 1, wherein
the condition information is information in which a display style is associated with each of a plurality of reference values, each of which is defined by the number of persons staying per unit time, and
the determining includes correcting the reference values using durations indicated by the display target period, and
wherein the threshold values are determined by using the condition information in which the reference values are corrected.

3. The display method according to claim 1, wherein
the condition information includes a plurality of pieces of sub-condition information, each corresponding to one of a plurality of time periods,
each of the plurality of pieces of sub-condition information is information in which a display style is associated with each of a plurality of reference values defined by the number of staying persons, and
in the determining, the threshold values are determined by using reference values included in a piece of sub-condition information corresponding to a time period indicated by the display target period among the plurality of pieces of sub-condition information.

4. The display method according to claim 1, wherein
the condition information includes a plurality of pieces of sub-condition information, each corresponding to a location condition of the store,
each of the plurality of pieces of sub-condition information is information in which a display style is associated with each of a plurality of reference values defined by the number of staying persons, and
in the determining, the threshold values are determined by using reference values included in a piece of sub-condition information corresponding to a location condition of the display target store among the plurality of pieces of sub-condition information.

5. The display method according to claim 1, wherein
the condition information includes a plurality of pieces of sub-condition information, each corresponding to a service provided by the store,
each of the plurality of pieces of sub-condition information is information in which a display style is associated with each of a plurality of reference values defined by the number of staying persons, and
in the determining, the threshold values are determined by using reference values included in a piece of sub-condition information corresponding to a service provided by the display target store among the plurality of pieces of sub-condition information.

6. The display method according to claim 1, wherein
in the calculating, the number of persons, staying in each area within the display target store for the display target period at predetermined time intervals, is calculated and
in the generating, the map screen is generated at the predetermined time intervals by classifying the numbers of persons staying in each area calculated at the predetermined time intervals by using the determined threshold values, and
in the displaying, the map screens is displayed in chronological order.

7. The display method according to claim 1, wherein
in the calculating, in a case where a plurality of display target stores are selected in the selecting, the numbers of persons, for each area, staying in the plurality of display target stores,
in the determining, a plurality of threshold values, corresponding to the plurality of display target stores, are determined, and
in the classifying, the calculated numbers of persons staying in the plurality of display target stores for each area is classified by using corresponding threshold values among the determined plurality of threshold values,
in the generating, a plurality of map screens, each of which corresponds to one of the plurality of display target stores, are generated and
in the displaying, the plurality of map screens are displayed as a list on the display.

8. The display method according to claim 7, further comprising:
accepting instructions to select one of the plurality of map screens displayed as a list on the display;
modifying display styles on the plurality of map screens displayed as a list on the display,
wherein, in the classifying, the calculated numbers of persons, staying in the plurality of display target stores for each area, is classified by using a threshold value determined in the determination step for the display target store corresponding to the selected map screen, and
wherein in the modifying, the display styles are modified by using a result of the classification.

9. The display method according to claim 1, wherein
at least one of the receiving, the generation of the stay information, the saving, the selecting, the calculating, the determining, the classifying, the generation of the map screen, and the displaying is performed by a processor.

10. A stay information display system comprising:
a manager that collects stay information on stays of persons in a store;
a display controller that displays staying behavior of persons in the store on a display by using the collected stay information;
a receiver that receives state information including a location at which a person stays in the store, the state information being generated based on video data obtained by capturing an image of inside of the store;
a collection processor that generates stay information in which a location at which a person stays in the store and date and time at which the person stays in the store are associated with each other, by using the received state information;
an information saver that saves the generated stay information in a storage in association with store information indicating the store;
a selector that selects a display target period and a display target store;
an acquirer that calculates the numbers of persons staying in a plurality of areas within the display target store for the display target period, by using the saved stay information; and
an output data generator that:
determines threshold values in accordance with at least any one of the display target period and the display target store, by using condition information that specifies a condition for determining threshold values used to classify the numbers of persons staying in the plurality of areas within the store,
classifies the calculated numbers of persons staying in the plurality of areas by using the determined threshold values,
generates a map screen on which staying behaviors of persons in the plurality of areas are mapped onto a layout screen of the store by using display styles in accordance with a result of the classification, and
displays the map screen on the display.

11. The stay information display system according to claim 10, wherein
the condition information is information in which a display style is associated with each of a plurality of reference values, each of which is defined by the number of persons staying per unit time, and
the output data generator corrects the reference values using durations indicated by the display target period, and
wherein the threshold values are determined by using the condition information in which the reference values are corrected.

12. The stay information display system according to claim 10, wherein
the condition information includes a plurality of pieces of sub-condition information, each corresponding to one of a plurality of time periods,
each of the plurality of pieces of sub-condition information is information in which a display style is associated with each of a plurality of reference values defined by the number of staying persons, and
the output data generator determines the threshold values by using reference values included in a piece of sub-condition information corresponding to a time period indicated by the display target period among the plurality of pieces of sub-condition information.

13. The stay information display system according to claim 10, wherein
the condition information includes a plurality of pieces of sub-condition information, each corresponding to a location condition of the store,
each of the plurality of pieces of sub-condition information is information in which a display style is associated with each of a plurality of reference values defined by the number of staying persons, and
the output data generator determines determine the threshold values by using reference values included in a piece of sub-condition information corresponding to a location condition of the display target store among the plurality of pieces of sub-condition information.

14. The stay information display system according to claim 10, wherein
the condition information includes a plurality of pieces of sub-condition information, each corresponding to a service provided by the store,
each of the plurality of pieces of sub-condition information is information in which a display style is associated with each of a plurality of reference values defined by the number of staying persons, and
the output data generator determines the threshold values by using reference values included in a piece of sub-condition information corresponding to a service provided by the display target store among the plurality of pieces of sub-condition information.

15. The stay information display system according to claim 10, wherein
the acquirer calculates the number of persons staying in each area within the display target store for the display target period at predetermined time intervals,
the output data generator generates the map screen at the predetermined time intervals by classifying the numbers of persons staying in each area calculated at the predetermined time intervals by using the determined threshold values, and
the output data generator displays the map screens in chronological order.

16. The stay information display system according to claim 10, wherein
the output data generator:
calculates, in a case where a plurality of display target stores are selected by the selector, the numbers of persons, for each area, staying in the plurality of display target stores;
determines a plurality of threshold values corresponding to the plurality of display target stores;
classifies the calculated numbers of persons staying in the plurality of display target stores for each area by using corresponding threshold values among the determined plurality of threshold values;
generates a plurality of map screens each of which corresponds to one of the plurality of display target stores, and
displays the plurality of map screens as a list on the display.

17. The stay information display system according to claim 16, wherein
the output data generator:
in a case where instructions to select one of the plurality of map screens displayed as a list on the display is accepted by the selector,
classifies the calculated numbers of persons staying in the plurality of display target stores for each area by using a threshold value determined for the display target store corresponding to the selected map screen; and
modifies display styles on the plurality of map screens displayed as a list on the display by using a result of the classification.

18. A display control device connected to a management device that receives state information including a location at which a person stays in a store, the state information being generated based on video data obtained by capturing an image of inside of the store, that generates stay information in which a location at which a person stays in the store and date and time at which the person stays in the store are associated with each other, by using the received state information, and that saves the generated stay information in a storage device, the display control device comprising:
a selector that selects a display target period and a display target store;
an acquirer that acquires the saved stay information, and calculate the numbers of persons staying in a plurality of areas within the display target store for the display target period, by using the acquired stay information; and
an output data generator that:
determines threshold values in accordance with at least any one of the display target period and the display target store, by using condition information that specifies a condition for determining threshold values used to classify the numbers of persons staying in the plurality of areas within the store;
classifies the calculated numbers of persons staying in the plurality of areas by using the determined threshold values;
generates a map screen on which staying behaviors of persons in the plurality of areas are mapped onto a layout screen of the store by using display styles in accordance with a result of the classification, and
displays the map screen on the display.

19. The display control device according to claim 18, wherein
at least one of the selector, the acquirer and the output data generator includes a processor.
